(19) United States
(12) Patent Application Publication
(10) Pub. No.: US 2012/0134328 A1
(43) Pub. Date: May 31, 2012

(54) METHOD AND APPARATUS FOR DYNAMIC SPECTRUM MANAGEMENT

(75) Inventors: Jean-Louis Gauvreau, La Prairie (CA); Martino M. Freda, Laval (CA); Parul Mudgal, New Delhi (IN); Athmane Touag, Laval (CA); Liangping Ma, San Diego, CA (US); Chunxuan Ye, Wayne, PA (US); Rocco DiGirolamo, Laval (CA); Angelo A. Cuffaro, Laval (CA); Saad Ahmad, Montreal (CA)

(73) Assignee: INTERDIGITAL PATENT HOLDINGS, INC., Wilmington, DE (US)

(21) Appl. No.: 13/270,038

(22) Filed: Oct. 10, 2011

Related U.S. Application Data
(60) Provisional application No. 61/391,901, filed on Oct. 11, 2010.

(51) Int. Cl. H04W 72/04; H04W 12/06; H04B 7/24

(52) U.S. Cl. 370/329

(57) ABSTRACT

Described herein are methods, apparatus and architecture for dynamic spectrum management (DSM) including protocol stacks, logical entities and functionalities that support DSM operation in opportunistic spectrum such as television white space (TVWS). The architecture supports aggregating bandwidth at the internet protocol (IP) layer over licensed and opportunistic bands as well as noncontiguous spectrum aggregation at the medium access control (MAC) layer. The control plane protocol stack includes a multi network transport protocol (MNTP), a channel management (CM) protocol, a policy protocol, a medium access control (MAC) entity, a physical entity and an air interface, all of which are configured to allocate, monitor, and update aggregated spectrum resources with respect to a DSM client.

### CROSS REFERENCE TO RELATED APPLICATIONS

This application claims the benefit of U.S. provisional application No. 61/391,901, filed Oct. 11, 2010, the contents of which are hereby incorporated by reference herein.

### FIELD OF INVENTION

This application is related to wireless communications.

### BACKGROUND

Dynamic Spectrum Management (DSM), which may also be known as Dynamic Spectrum Access, may allow spectrum access by cognitive radios when primary spectrum users (PUs) do not use the spectrum, resulting in better spectrum utilization and improved system performance. The devices in the DSM system that may access the spectrum of the PUs when the PUs do not use the spectrum are called secondary spectrum users (SUs).

Local wireless networks are often bandwidth constrained as more bandwidth demanding wireless applications are deployed in the home or in the office. To solve this, it may be necessary to operate in new and emerging spectra such as television white space (TVWS). However, spectrum such as TVWS may require devices operating in a local wireless network to operate as SUs. For example, the local wireless network must detect the presence of PUs and ensure that the local wireless network does not interfere with a detected PU. Alternatively, the DSM may query a TVWS database to get channel availability based on the location of the local network and the relative position of the registered PUs. Therefore, the local wireless may need to adapt to a rapidly changing and dynamic spectrum allocation.

Allowable channels that may be used by SUs in emerging spectra are often discontinuous chunks of spectra. Current wireless technology may not operate over a noncontiguous spectrum allocation. In order to maximize the bandwidth usable by a system or a user, the simultaneous use of discontinuous chunks of a spectrum may be needed.

### SUMMARY

Described herein are methods, apparatus and architecture for dynamic spectrum management (DSM) including protocol stacks, logical entities and functionalities that support DSM operation in opportunistic spectrum such as television white space (TVWS). The architecture supports aggregating bandwidth at the internet protocol (IP) layer over licensed and opportunistic bands as well as noncontiguous spectrum aggregation at the medium access control (MAC) layer. The control plane protocol stack includes a multi network transport protocol (MNTP), a channel management (CM) protocol, a policy protocol, a medium access control (MAC) entity, a physical entity and an air interface, all of which are configured to allocate, monitor, and update aggregated spectrum resources with respect to a DSM client.

### BRIEF DESCRIPTION OF THE DRAWINGS

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 is an example dynamic spectrum management (DSM) system architecture;

FIG. 3 is an example DSM system control plane protocol stack;

FIG. 4 is an example DSM system user plane protocol stack;

FIG. 4A is an example DSM system control plane protocol stack for long term evolution (LTE);

FIG. 5 is an example DSM engine architecture;

FIG. 6 is an example control channel initialization with Mode II operation;

FIG. 7 is an example control channel initialization with Mode II operation in conjunction with sensing capabilities;

FIG. 8 shows an example attachment and admission control architecture and method;

FIG. 9 shows an example Internet Protocol (IP) aggregation;

FIG. 10 shows an example channel change;

FIG. 11 shows an example architectural view of direct link setup;

FIG. 12 shows an example service request architecture;

FIG. 13A shows an example of resource management and allocation by a DSM engine;

FIG. 13B shows an example allocation by a DSM engine;

FIG. 14 shows example DSM client logical functions;

FIG. 15 shows an example Institute of Electrical and Electronics Engineers (IEEE) 802.19.1 architecture;

FIG. 16 shows an example mapping of an IEEE 802.19.1 to DSM architecture;

FIG. 17 shows an example hierarchical IEEE 802.19.1 system with DSM entities;

FIG. 18 shows example DSM channel management function (CMF) sub-functions; and

FIG. 19 shows example sensing processor sub-functions.

### DETAILED DESCRIPTION OF THE EMBODIMENTS

Described herein are example communication systems that may be applicable and may be used with the description herein below. Other communication systems may also be used.

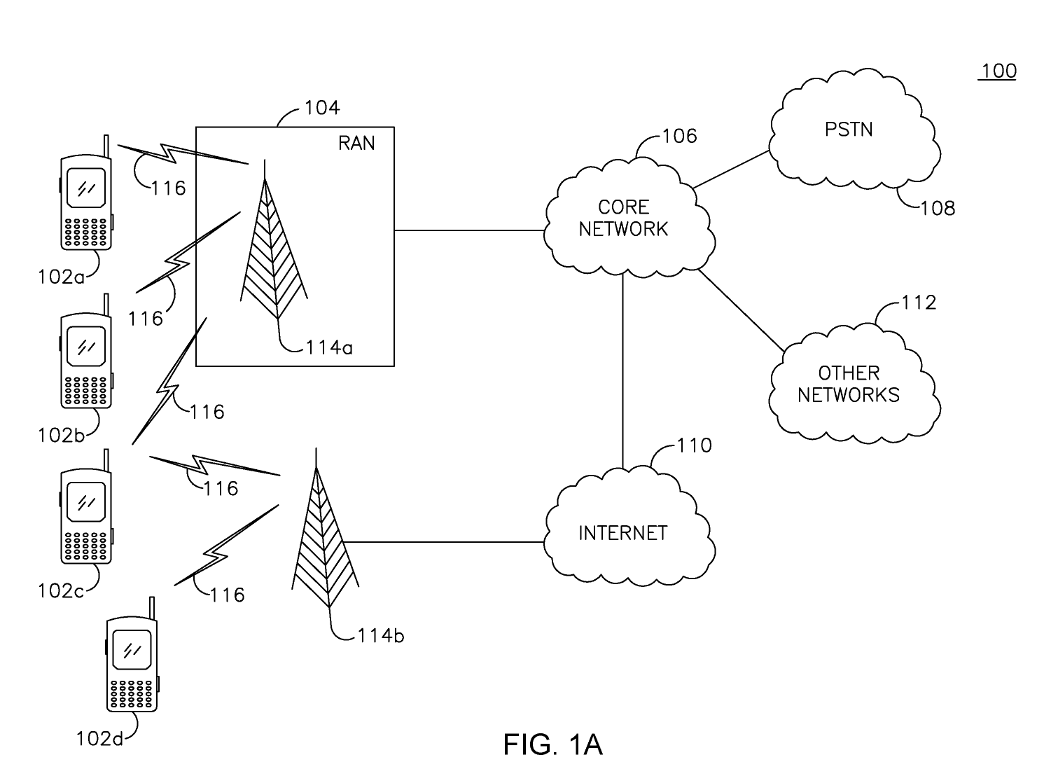

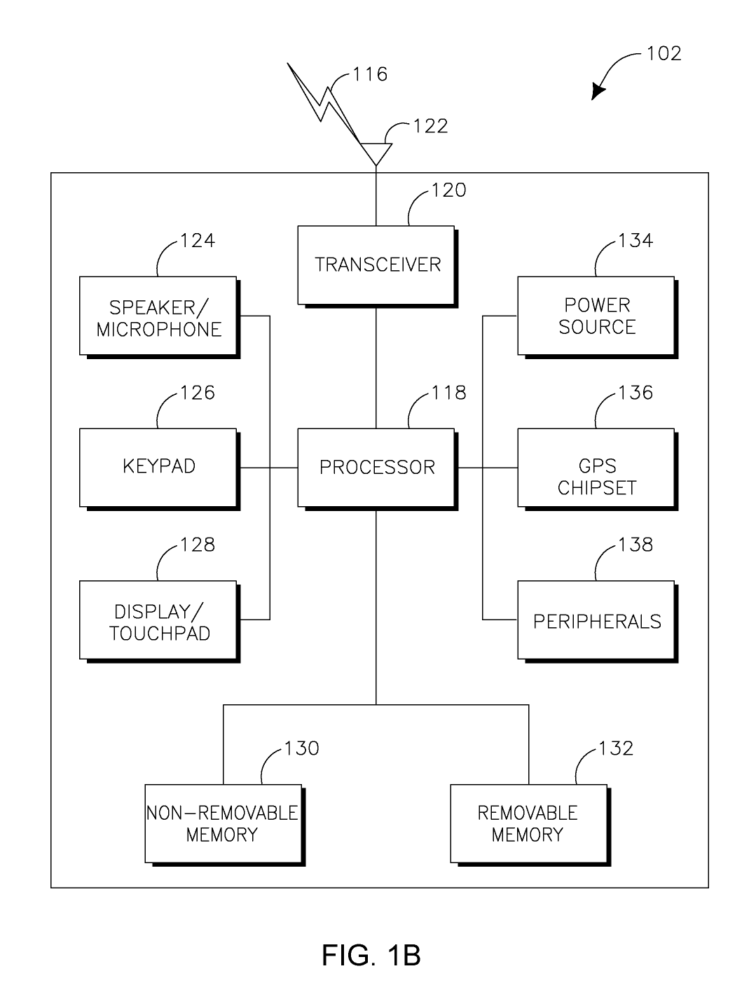

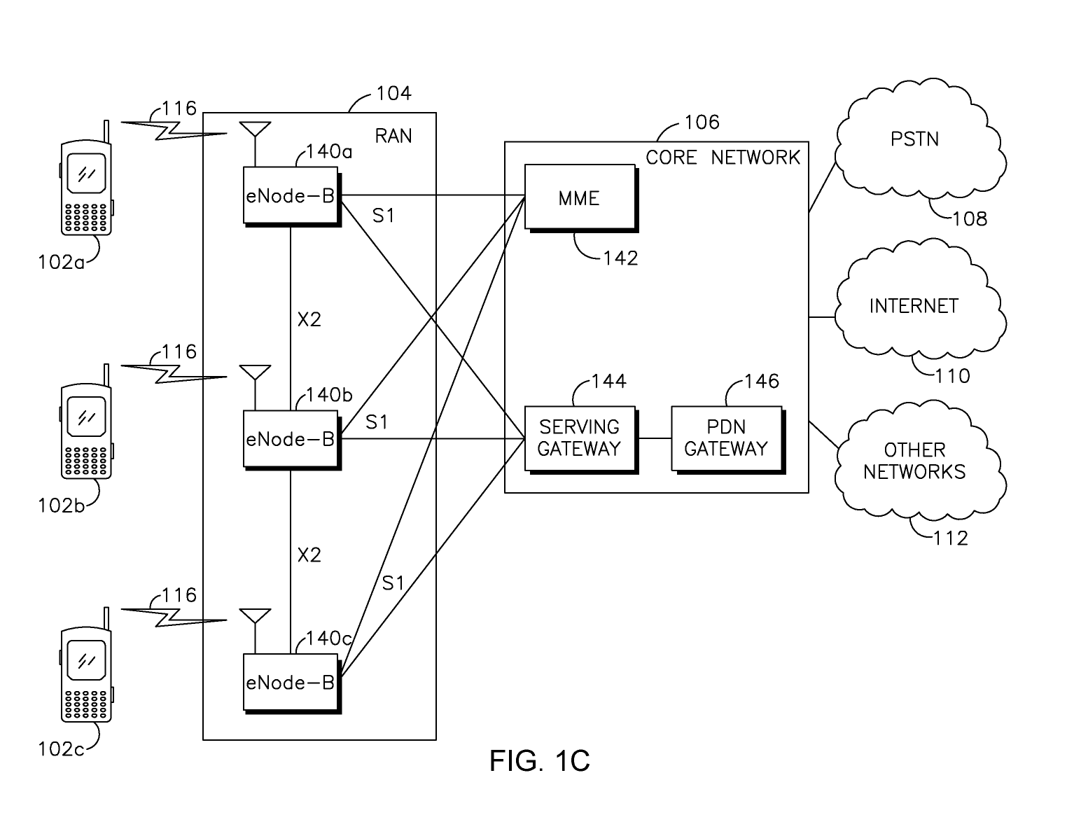

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it may be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it may be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it may be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It may be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it may be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It may be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It may be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it may be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it may be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

The description herein may use the following terms and may have the following definitions in addition to or that may supplement those used in the art. A DSM system may refer to the system comprising one (or more) DSM engines controlling and assisting various local networks and direct links. A DSM client may refer to a device that has a communication link to the DSM engine and may be part of a local network or a direct link. A DSM engine may be an entity responsible for spectrum management as well as coordination and management of local networks and direct links. A DSM link may refer to a communication link between DSM engine and DSM client, providing control plane and user plane functionality. A direct link may refer to a link between two dynamic spectrum management (DSM) clients. Operating channel(s) may be channel(s) chosen for the DSM communication links. An attachment may refer to the process by which a DSM client discovers the DSM operating channel, synchronizes to this channel, associates with the AP and informs the DSM engine of its presence and its capabilities. Discovery Process may refer to a process by which a DSM client finds the operating channel of the DSM engine, (scans to find the control channel and synchronizes to the DSM).

The descriptions herein may refer to television white space (TVWS) as an example of an opportunistic bandwidth or opportunistic frequency band. The same description may apply for operation in any opportunistic frequency bands where devices may operate opportunistically when certain defined priority users (primary users) are not operating. In addition, a database of priority users or primary users for an opportunistic band may be maintained in a database. For operation in TVWS, this database may be referred to as the TVWS database. However, operation with a similar database may be possible in any opportunistic band. Other non-limiting examples of opportunistic bands, opportunistic bandwidth or opportunistic frequency band may include unlicensed bands, leased bands or sublicensed bands.

An enabling station may refer to a station that has the authority to control when and how a dependent station may operate. An enabling station communicates an enabling signal, to its dependants, over the air. The enabling station may correspond to a Master (or Mode II) device in Federal Communications Commission (FCC) nomenclature. In the above context, “registered” may mean that the station has provided the necessary information to TVWS database, (e.g. FCC Id, location, manufacturer information, and the like).

Geo-location capability may refer to the capability of a TVWS device to determine its geographic coordinates within the level of accuracy, such as 50 meters, as a non-limiting example.

Industrial, Scientific and Medical (ISM) bands may refer to frequency bands open to unlicensed operation, governed by Part 15 Subpart B FCC rules in the US. For example, 902-928 MHz Region 2 only, 2.400-2.500 GHz, 5.725-5.875 GHz.

A Mode I device may be a personal/portable TVWS device that does not use an internal geolocation capability and access to a TV bands database to obtain a list of available channels. A Mode I device may obtain a list of available channels on which it may operate from either a fixed TVWS device or a Mode II device. A Mode I device may not initiate a network of fixed and/or personal/portable TVWS devices nor may it provide a list of available channels to another Mode I device for operation by such device. A Mode II device may be a personal/portable TVWS device that uses an internal geo-location capability and access to a TVWS database, either through a direct connection to the Internet or through an indirect connection to the Internet by way of fixed TWWS device or another Mode II TVWS device, to obtain a list of available channels. A Mode II device may select a channel itself and initiate and operate as part of a network of TVWS devices, transmitting to and receiving from one or more fixed TVWS devices or personal/portable TVWS devices. A Mode II device may provide its list of available channels to a Mode I device for operation on by the Mode I device. A sensing only device may refer to a personal/portable TVWS device that uses spectrum sensing to determine a list of available channels. Sensing only devices may transmit on any available channels in the frequency bands 512-608 MHz (TV channels 21-36) and 614-698 MHz (TV channels 38-51), for example.

TVWS bands may refer to TV channels, (in the VHF (54˜72, 76˜88, 174˜216 MHz) and UHF (470˜698 Mhz) bands), where regulatory authorities permit operation by unlicensed devices. Personal/portable devices which include Mode I, Mode II and sensing only devices, may transmit on available channels in the frequency bands 512-608 MHz (TV channels 21-36) and 614-698 MHz (TV channels 38-51). A primary user (PU) may refer to the incumbent user of a TVWS channel.

Described herein is a Dynamic Spectrum Management (DSM) system including protocol stacks, logical entities and functionalities that support DSM operation in spectrum such as television white space (TVWS).

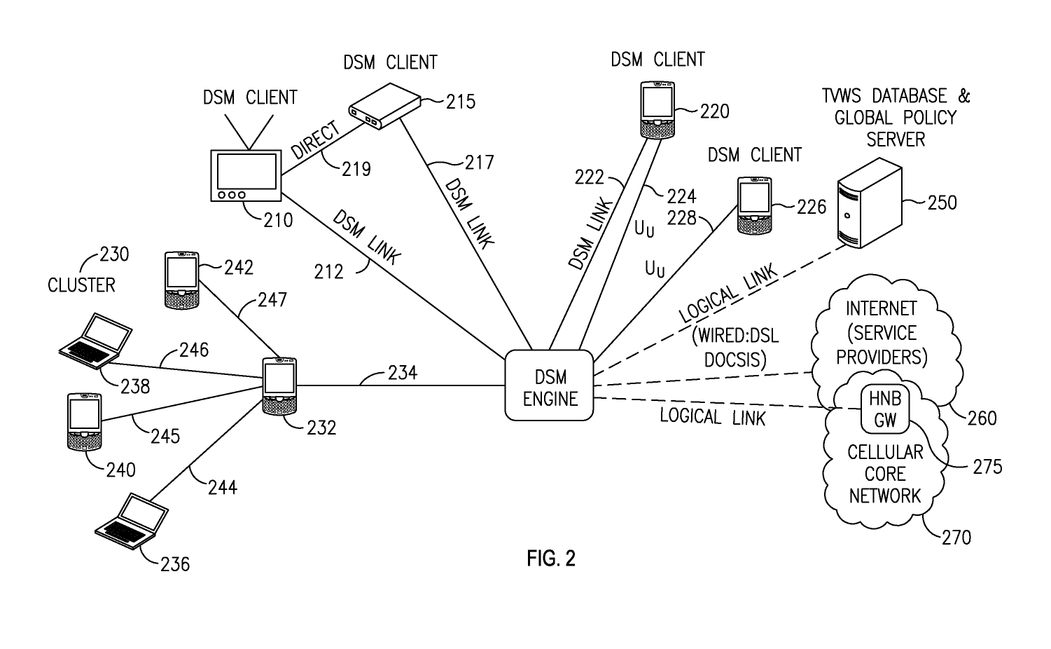

FIG. 2 shows an example DSM system 200 that may operate in a local area such as a home or a small office and may be composed of at least one DSM engine 205. The DSM engine 205 may be connected to multiple DSM clients through multiple DSM links. Other than the DSM engine, wireless devices operating in the local network are referred as DSM clients. For example, the DSM engine 205 may be connected to a television 210 and a set top box or similar device 215 (example DSM clients) via DSM links 212 and 217, respectively. The television 210 and a set top box or similar device 215 may be connected via a direct link 219. A WTRU 220 may be connected to the DSM engine 205 via a DSM link 222, an air interface link 224, (such as an LTE or UMTS air interface link), or both. Another WTRU 226 may be connected to the DSM engine 205 via an air interface link 228.

An Institute of Electrical and Electronics Engineers (IEEE) 802.11 cluster 230 may be connected to the DSM engine 205 through an access point (AP) 232 via a DSM link 234. The cluster 230 may include laptops 236 and 238 and WTRUs 240 and 242, all of which are connected to the App 232 via 802.11 links 244-247.

The DSM engine 205 is further connected to a TVWS database and a global policy server 250, (which may be multiple entities and not co-located), an Internet 260 and a cellular core network 270. For instance, the DSM engine 205 may be connected to a home evolved node B (H(e)NB) 275.

As shown, the DSM engine 205 may manage all wireless communication taking place in the local area operating in unlicensed bands, (such as but not limited to 2.4 GHz and 5 GHz ISM bands, TVWS bands and 60 GHz bands), as well as aggregating bandwidth over licensed and unlicensed bands. The DSM engine 205 may be interconnected to the external networks such as the cellular network, TVWS database and the IP networks through a wireless wide area network (WWAN) or wire line links.

The DSM engine 205 may operate in the TVWS band as a Mode II device as defined in FCC's Second Memorandum Opinion and Order (FCC 10-174) since it may have access to the TVWS database 250 and have geo-location capability. Furthermore, the DSM engine 205 may also operate in sensing only mode, which may potentially allow the DSM system 200 to operate in a larger subset of channels than what the TVWS database 250 may allow.

Described herein are DSM clients. DSM clients may be cognitive radio enabled client devices capable of establishing a communication link with the DSM engine 205 directly. The communication link between the DSM engine 205 and the DSM clients may be referred to as DSM links and provide enhanced control plane and user plane functionalities. The DSM links of the DSM system 200 may be based on, as a non-limiting example, an enhanced IEEE 802.11 radio access technology (RAT) capable of operating over non-contiguous spectrum in TVWS. The DSM links may be based on other RATs such as LTE.

The DSM clients may operate as a Mode I device, since such devices do not have access to the TVWS database 250 and may rely on the DSM engine 205 to indicate which channels may be used. Furthermore, DSM clients may also operate in a sensing only mode. In that case, for channels identified by the DSM engine 205 as sensing only mode channels, the DSM clients may have to periodically verify that no PU occupies these channels to enable transmission in these channels. The DSM engine 205 may schedule silent periods to enable adequate spectrum sensing on these channels at the DSM clients.

A DSM client with sensing only capability may operate on a subset of channels as a Mode I device. For these channels, there is no need to detect the arrival of a primary user.

DSM clients may communicate directly with each other through what is called a direct link. The radio resources and RAT used for the direct link may be controlled by the DSM engine 205.

In summary, the DSM system 200 may operate in TVWS where the DSM engine 205 is a Mode II device and the DSM clients in range of the DSM engine 205 may operate as Mode I devices. Furthermore, both the DSM engine 205 and DSM clients may support sensing only mode which enables the system to complement the subset of channels allowed by the TVWS database 250 with a potentially larger subset of channels based on sensing only mode.

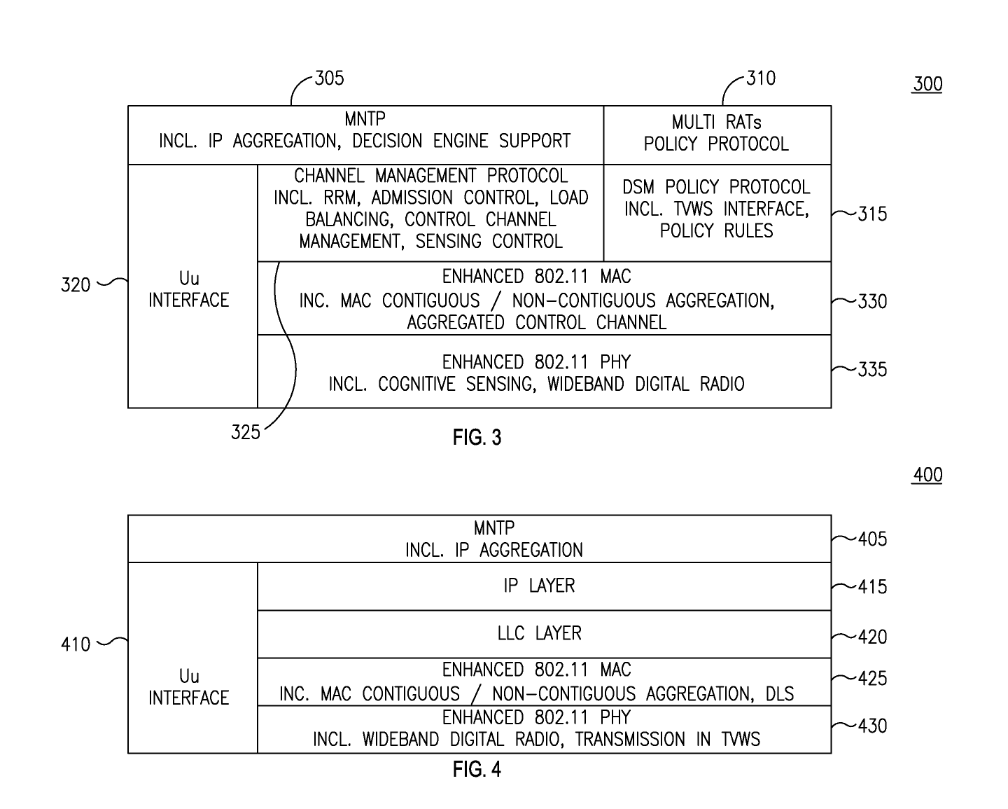

Described herein is a DSM system protocol stack. FIG. 3 shows an example control plane protocol stack 300 supported by the DSM clients and the DSM engine. The control place protocol stack 300 may include a multi network transport protocol (MNTP) 305 that acts as an application protocol sitting across multiple access technologies. The MNTP 305 may establish multiple parallel sessions over multiple radio access technologies (RATs) between a DSM client and the DSM engine. Internet Protocol (IP) aggregation of multiple IP streams may also be performed by the MNTP 305. The network health of ongoing sessions are collected (measured) by the network manager entities on the multi network connection (MNC) client and based on these measurements, a decision engine driven by application requirements may trigger the MNTP 305 to start a new session or terminate an existing session of a particular RAT.

The control place protocol stack 300 may further include a policy protocol 310 for multi-RAT and DSM. The policy protocol 310 may generate the policy rules based on inputs from the TVWS database and additional system-wide rules that a network operator or an enterprise customer may typically define. These policy rules may serve as inputs to a channel management (CM) protocol 325 as described herein and relate to spectrum management and network configuration of the unlicensed bands and TVWS. The policy protocol 310 may follow a hierarchical structure where system-wide policies may apply across multiple RATs. This may be referred to as the multi-RATs policy protocol. Underneath the policy protocol 310, a DSM policy protocol 315 may take inputs from the TVWS database and policies from the multi-RATs policy protocol 310 applicable to the TVWS. In another embodiment, where a channel management function (CMF) may control other operating bands (e.g., ISM bands), the DSM policy engine may expand its scope beyond just TVWS.

As described hereinbefore, the control place protocol stack 300 may also include the CM protocol 325. The CM protocol 325 may act as a network protocol handling all wireless communications operating in TVWS bands. The CM protocol 325 may support the admission control of the DSM clients and the radio resources used by the APs, (as described herein below), and the DSM clients.

Also included in the control place protocol stack 300 are enhanced IEEE 802.11 medium access control (MAC) and enhanced IEEE 802.11 physical (PHY) entities. The 802.11 MAC protocol may be enhanced to support MAC aggregation of noncontiguous spectrum in TVWS, new aggregated control channel operation and new MAC control messages. The 802.11 PHY protocol may be enhanced to support new cognitive sensing techniques and to operate over noncontiguous spectrum in TVWS using a wideband digital radio. The Uu Interface 320 may be a standard Uu interface integrated in DSM clients and in a H(e)NB, for example, within the DSM engine to enable IP aggregation over both licensed and unlicensed bands.

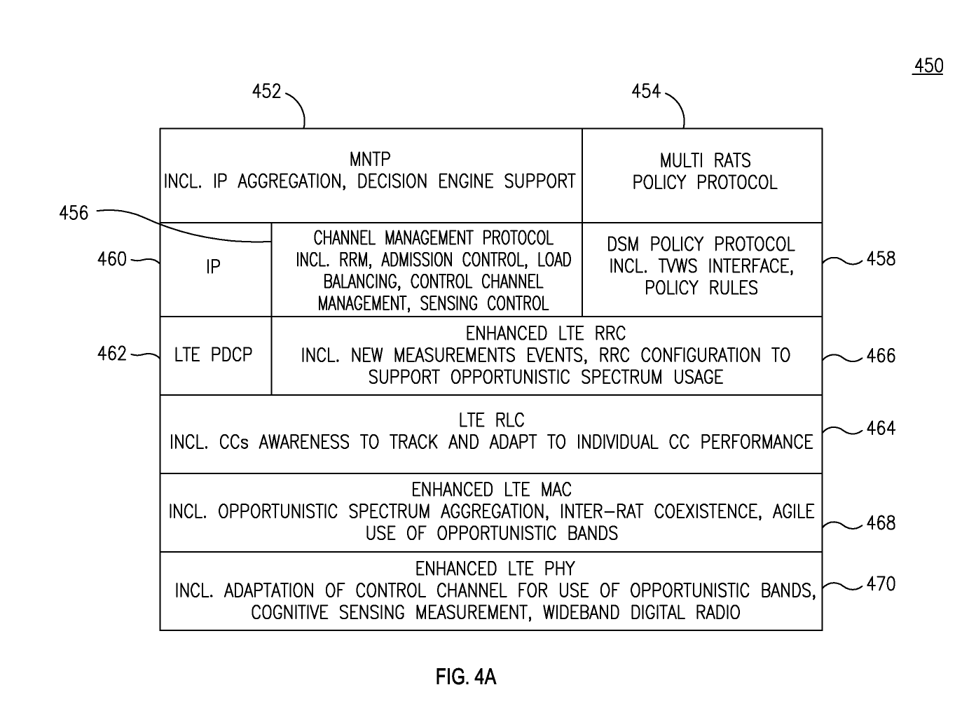

FIG. 4 shows an example user plane protocol stack 400 for a DSM system. In comparison with the configuration for a standard IEEE 802.11 protocol stack, the user plane protocol stack may replace the standard IEEE 802.11 protocol stack transmission control protocol (TCP)/user datagram protocol (UDP) with the MNTP 405. The MNTP 405 may include IP aggregation, and the modifications to the 802.11 PHY and MAC to support the DSM link. The user plane protocol stack 400 may also include a Uu Interface 410, an IP entity 415, and a Logical Link Control (LLC) entity 420. In addition, similar to the control plane protocol stack 300, the user plane protocol stack 400 may include enhanced IEEE 802.11 MAC entity 425 and enhanced IEEE 802.11 PHY entity 430. For example, stack entities that may be common to both data and control planes may have some similar functionality, some functionality that is data related, some functionality that is control related and some functionality that is both data and control related. For example, the enhanced PHY has a cognitive sensing functionality, which is related entirely to control, and a wideband digital radio which is related to both control and data, (since both control and data are transmitted using this wideband digital radio).

As stated herein the DSM link may be based on other RATs. For example, the DSM link may be based on an enhanced LTE RAT capable of operating over noncontiguous spectrum in opportunistic bands such as TVWS. FIG. 4A shows an example protocol stack 450 supported by the DSM clients and the DSM engine. In this context, the DSM engine may be a function in a base station such as a H(e)NB. The DSM client may be a LTE WTRU. As before, the protocol stack 450 may include a MNTP 452 and a multi-RATs policy protocol 454. The stack may include a DSM policy protocol 458, a Channel Management Protocol (CMP) 456, an IP module/entity 460, a LTE PDCP 462, a LTE RLC 464, a LTE RRC 466, a LTE MAC 468 and a LTE PHY 470, some of which are further described herein.

The CMP 456 may act as a network protocol handling all wireless communication operating over the opportunistic bands. In the LTE context, the DSM engine in the base station may also be assigned licensed bands. It may signal the decision to operate only in opportunistic bands, only in licensed bands or in both bands simultaneously. It may aggregate both licensed bands and opportunistic bands. Based on measurements received from a RRC entity or layer collected from the WTRUs, or sensing information collected from a sensing processor residing in the base station or information from a database, (such as the TVWS database), the DSM engine may decide to allocate additional cells, terminate cells or reconfigure a cell to operate over a new channel. The CMP 456 may also support the admission control of the DSM clients and the radio resources used by the base station as described herein and the DSM clients. Control channel management may also configure a MAC layer or entity to coexist with other RATs or signal the MAC entity that it may reconfigure to operate over a different frequency. Control channel management may configure the PHY layer and the associated control channel such as the synchronization channel, the physical downlink control channel (PDCCH), Physical Hybrid Automatic Repeat Request Indicator Channel (PHICH), and physical control format indicator channel (PCFICH) to operate in a robust manner to allow coexistence in the opportunistic bands.

The LTE RRC 466 may be enhanced to support new measurement events or measurement configurations related to the detection of a primary user, or events related to the presence of secondary users. The RRC layer or entity may also be enhanced to support new operating modes associated with operating in opportunistic bands, such as downlink only operation, uplink only operation, shared downlink/uplink operation or operation changes related to the type of channels being used, (i.e. primary user detection required, secondary user present).

The LTE MAC protocol 468 may be enhanced to support opportunistic MAC aggregation of noncontiguous spectrum in opportunistic bands such as TVWS. The use of opportunistic bands may require some changes to the MAC to coexist with other RATs. The MAC layer or entity may signal to the WTRU the command to change the operating frequency of the active cell.

The LTE PHY protocol 470 may be enhanced to support new cognitive sensing techniques and the adaptation to operate over noncontiguous spectrum of opportunistic bands using a wideband digital radio. Other enhancements to the associated control channel may include changes to the synchronization channel, the PDCCH, PCFICH and PHICH to operate in a robust manner in presence of high interference or to support coexistence with secondary users.

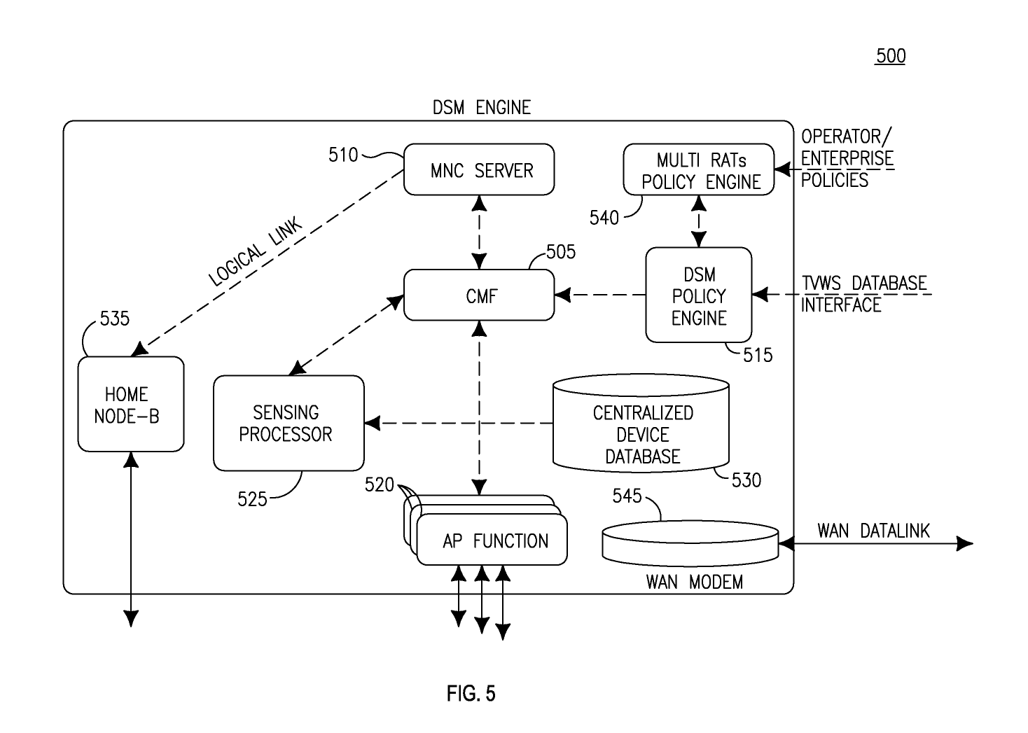

A DSM engine 500 may be divided into the following logical functions as shown in FIG. 5 including a channel management function (CMF) 505 which may be logically linked to a MNC server 510, a DSM policy engine 515, an AP function entity 520, a sensing processor (SP) 525, and a centralized device database 530. The DSM engine 500 may also include a H(e)NB function entity 535 that is logically connected to the MNC server 510. The H(e)NB function entity 535 may connected via a standard UMTS or LTE air interface to a network (not shown). The DSM engine 515 may be further logically linked to a multi RATs policy engine 540, which in turn may be logically linked to operator/enterprise policies. The DSM policy engine 515 may be logically linked to a TVWS database (not shown). A wireless area network (WAN) modem 545 may also be included in the DSm engine 500, where the WAN modem 545 may be connected to external devices via a WAN data link. The AP function 520 may be further connected to external devices via a DSM link.

The CMF 505 is the central resource controller responsible for managing the radio resources and allocating them efficiently to each of the devices and APs. This logical function may also manage admission control of the DSM clients and maintain the centralized device database 530. The CMF 505 may directly handle bandwidth requests by the DSM clients. In order to satisfy these bandwidth requests, the CMF 505 may maintain a common pool of spectrum resources which it identifies and updates continuously using information provided by the SP 525 and the DSM policy engine 515. Once bandwidth is allocated to a given AP and its associated DSM clients, a new control message mechanism may inform the DSM clients of the aggregated spectrum to be used. Since the spectrum utilization may be expected to change with time, the control channel may be used to dynamically update or change the resources to be utilized by each of the DSM clients. The CMF 505 includes a control channel management function which manages the delivery of control messages for channel change, beaconing and failure case handling. This function may also ensure the delivery of advanced new control messages such as paging, service discovery and direct link setup. For example, based on the client requests, client capabilities, client locations and the radio resource availability, the CMF 505 may decide to handle the requests by establishing a direct link between two or more clients. The enhanced control channel ensures that the DSM system operates reliably and efficiently under uncoordinated and heavy interference and under constant spectrum usage change. The CMF 505 may identify and maintain a pool of available spectrum with the help of the SP 525.

Radio resource allocation by the CMF 505 may conform to rules generated by the DSM policy engine 515. The DSM policy engine 515 may generate the policy rules based on inputs from the TVWS database and additional system wide rules that a network operator or an enterprise customer may typically define. These additional rules come from the multi RATs policy engine 540, where the network operator may define spectrum management rules such as preferred operating channels, blacklisted channels and system wide power consumption configuration. The CMF 505 may collect performance inputs from the DSM system including buffer occupancy, overall latency, delivery success rate, channel utilization, and medium access delay.

User specific policies generated from a decision engine, (e.g., Attila decision engine), may be sent through a network manager interface specific for the DSM link and then the policies may be transferred to the CMF client as described herein below. The CMF client may inform the CMF 505 in the DSM engine 500 of the user preferences.

The CMF 505 may manage one or more AP functions 520. The AP function 520 may provide the basic MAC/PHY functionality to initiate and maintain connectivity to a group of DSM clients. Multiple groups of DSM clients may be supported in a DSM system. The AP function 520 may be enhanced to support the new control channel schemes as well as noncontiguous spectrum aggregation by the MAC layer. An AP function may typically be assigned a dedicated aggregated channel pool to handle both control and data messages, by the CMF 505.

The SP 525 may also control the sensing operation of the DSM client operating in sensing only mode in the network. The centralized device database 530 may store device-specific information for all the devices in the network that have been associated to the DSM engine 500.

The logical functions are meant to operate independently and perform well-defined tasks while maintaining a modular interface with the other functions. Implementation of the DSM engine 500 may allow for some logical entities to not be collocated. For example, multiple AP functions may be distributed in the local area.

Described herein are functional descriptions of the above noted functional entities. The MNC server 510 may be the main controller of IP sessions established through the MNTP protocol. The MNC server 510 may act as the main interface to the domain name server (DNS) and application when IP aggregated sessions are created. The actual decision to aggregate IP streams may be performed by the MNC client. For purposes of illustration, the MNC server may communicate with the DNS server to establish an IP connection with the core network, open external sockets to the application server upon request by the MNC client and receive IP information from the MNC client on aggregated stream.

The CMF 505 may be the central resource controller responsible for managing and allocating the radio resources efficiently to each of the devices and APs. The CMF 505 may ensure that the DSM system operates reliably and efficiently under uncoordinated and heavy interference and under constant spectrum usage change. This entity may also manage the control channel, the admission control of clients and the centralized device database. The responsibilities of the CMF 505 may include a bandwidth allocation algorithm to select dynamically what aggregated spectrum to be used on a AP basis. For example, if the DSM engine 500 operates as a Mode II device only, the aggregated pool may be selected from the available channels identified by the TVWS database. If the DSM engine 500 may operate also as a sensing only device, the aggregated pool may be selected from both the available channels identified by the TVWS database as well as channels where no primary user is detected. Channel available by sensing only mode but not available according to the TVWS database may be tagged as sensing only channel. Operation in sensing only channel may be different than with the other channels as described in subsequent section.

The CMF 505 may also perform a number of other functions, example of which are provided herein below. For example, the CMF 500 may perform a control channel management function that may include the delivery of control messages such as channel change, beaconing, and failure case handling. This may include notifying the AP or client of any change in the channels to be aggregated, (based on channel quality or sensing information). In the context of LTE, it may signal the decision to operate only in opportunistic bands, only in licensed bands or in both bands simultaneously using aggregation. It may aggregate both licensed bands and opportunistic bands. The base station may allocate additional cells, terminate cells or reconfigure a cell to operate over a new channel, Control channel management may configure the MAC layer/entity to coexist with other RATs or signal the MAC that it may reconfigure to operate over a different frequency. Control channel management may configure the PHY layer and the associated control channels such as the synchronization channel, the PDCCH, the PCFICH and PHICH to operate in a robust manner. In another example, the CMF 505 may deliver advanced new control messages such as paging, service discovery, and direct link setup. In another example, the CMF 505 may be the main control of the centralized device database 530. The admission control algorithm including notifying a client that the attachment request is rejected or accepted, may be implemented at or by the CML 505. The CMF 505 may collect performance inputs from the DSM system such as buffer occupancy, overall latency, delivery success rate, channel utilization, and medium access delay.

Other examples may include to query and control the sensing processor in order to obtain spectrum occupancy information, maintain a list of allocated and available spectrum (channels) and the client or AP that is using the spectrum, ensure that radio resource allocations conform to rules generated by the policy engine, respond to device queries, (a device on the network searching for another device), and selection of power savings operation routing and route reconfiguration, (i.e., reachability). In the later case, this may, in part, be done in the AP 520.

In other examples, the CMF 505 may handle requests for bandwidth from devices and APs registered in the centralized device database (future phases), generate spectrum allocations based on these requests and send the selected channels to the coordination function in the AP 520 or client for aggregation. The CMF 505 may manage proxy device association, maintain a list of proxy pairings, perform load balancing among clients under the DSM system, cluster modification decisions, (move device from one AP to another), handle network reconfiguration and assign elected AP.

The SP 525 may control the sensing operation among the sensing-capable nodes in the network. It may collect sensing information from the nodes and processes this information to facilitate the decision making in the CMF 505. In addition to using the SP 525 to find and maintain the pool of available spectrum, the CMF 505 may instruct the SP 525 to monitor specific bandwidth allocations that are actively being used by a device, (e.g., a direct link or a control channel). The CMF 505 may inform the SP 525 of the arrival or departure of sensing capable devices in the network, so that the SP 525 may properly manage the load of sensing all of the available spectrum. The CMF 505 may also manage location update messages from devices so that the SP 525 is aware of the change in location of a sensing-enabled device.

The SP 525 may also handle sensing requests from the CMF 505, query sensing capabilities and location information of devices from the centralized device database 530 and configure the sensing nodes based on this information. It may issue commands to sensing nodes to obtain information needed to configure sensing (e.g., correlation). It may also schedule sensing at specific time instances and triggers silent periods within the AP and devices.

Other examples may include to maintain a local sensing database which contains past sensing results and correlation information, perform fast-frequency selection (priority ordering) of channels based on past measurement results and relay this information to the CMF 505. It may coordinate sensing on a list of monitored channels provided by the CMF 505, detect interference on active or other channels in the TVWS, detect the presence of a primary user on monitored channels and indicate them to the CMF 505, and in particular for channels tagged as sensing only channels.

In further examples, the SP 525 may perform decision-fusion of sensing results from different nodes, select and configure a helper node for fusion and relay if that node supports intermediate fusion of results.

The AP function 520 may provide the main connectivity function for devices that join the network. It may contain a coordination function which manages the aggregation based on the channels selected by the CMF 505. The AP function 520 may perform IEEE 802.11 MAC/PHY functionality including: device association; device addressing, routing, and identification; synchronization and beacon transmission; multicast-broadcast; buffer management and scheduling; device coordination function; MAC segmentation and concatenation; prioritization buffering; and transmission, retransmission, and filtering of frames.

The AP function 520 may also support the new control channel schemes; perform contiguous and noncontiguous spectrum aggregation of channels determined by the CMF 505, support neighbor/node discovery and channel sounding (location estimation), and support control and common data channel setup procedures for the IEEE 802.11-based DSM link. It may further support direct link configuration, setup, tear-down, and maintenance, (e.g., assistance when devices move out of range of each other). In further examples, the AP function 520 may collect and compile MAC-layer channel qualities and congestion reports from devices and send them to the CMF 505, perform beam forming for devices communicating using 60 GHz, support a paging mechanism, and perform interference compensation and avoidance based on guidance from the CMF 505.

The DSM policy engine 515 may represent the enforcing entity of local regulatory rules and network operator rules within the DSM engine 500. The policy engine 515 may generate the policy rules based on inputs from the TVWS database and additional system wide rules that a network operator or an enterprise customer would typically input in the multi RATs policy engine 540.

The DSM policy engine 515 may store and maintain policies and spectrum availability information from the TVWS database. It may interface with the multi RATs policy engine 540 and the TVWS database to generate the following policy rules based on regulatory constraints on radio usage such as allowable frequencies, transmit power levels, antenna properties, or required licenses. The DSM policy engine 515 may further interface with the multi RATs policy engine 540 to generate the following system defined policy rules based on information received from the network operator: preferred operating channels; blacklisted channels; or power consumption configuration.

The DSM policy engine 515 may process performance inputs from the DSM system and modify the policy rules based on these inputs. Performance inputs used by the policy engine include buffer occupancy, overall latency and delivery success rate, power consumption and battery levels, or unlicensed bands performance measurements. It may translate policies to a RAT independent language which may be used by the CMF 505 to discover and utilize spectrum opportunities while conforming to rules and establish a communication link with the TVWS database and communicate with the TVWS database so that the DSM engine 505 may behave as a Mode II device in the IEEE 802.11 context, (i.e., sends GPS information and manufacturer information to the TVWS database and receives a list of channels which are currently not occupied by a DTV broadcast).

The CDD database 530 stores device-specific information for all of the devices in the network that have been associated to the DSM engine 500. The contents of the CDD 530 may include sensing capability, RAT capability, device location, capability of a node to be a helper node in sensor fusion, or connected state for each specific RAT.

The CDD 520 may support two basic operations: “information write” and “information read.” The CMF 505 may perform an “information write,” whereas all entities in the DSM engine may perform an “information read.” The contents (entries) of the CDD 520 for a particular device or AP in the network are shown in Table 1.

TABLE 1

| Field | Description |
|---|---|
| Device ID | Unique identifier for each device |
| Device Class | One of Class A-E |
| Location | Geographical location within the |
| | home or office |
| Service Capabilities | List of services provided by the device |
| | (e.g. direct link, P2P game) and |
| | limitations associated with the service |
| Sensing Capabilities | Sensing bandwidth, sensing |
| | algorithms supported, sensor fusion |
| | capabilities |
| RAT Capabilities | Supported RATs, supported TX and |
| | RX bandwidths, powers, sensitivities. |
| RAT Connected state | Connected state(s) for each RAT in |
| | the network. |
| Associated AP | The AP with which each device is |
| | associated, if any. |
| AP ID | Unique identifier for each AP |
| AP Capability | Buffer space, maximum number of |
| | devices it can support |
| AP Service Capability | List of services provided by the AP |
| | and limitations associated with the |
| | service |

The CDD 520 may support two basic operations: “information write” and “information read.” The CMF 505 may perform an “information write,” whereas all entities in the DSM engine may perform an “information read.” The contents (entries) of the CDD 520 for a particular device or AP in the network are shown in Table 1.

The following are example high level procedures of the DSM system. These operations focus on the main control plane features provided by the DSM engine 500 and illustrate the involvement of each DSM engine function in the realization of the operation. For each operation in which a procedure is specified in this section, the relevant portions of the architecture shown in FIG. 5 may be extracted in order to show the interaction between the DSM engine functions in the realization of the operation.

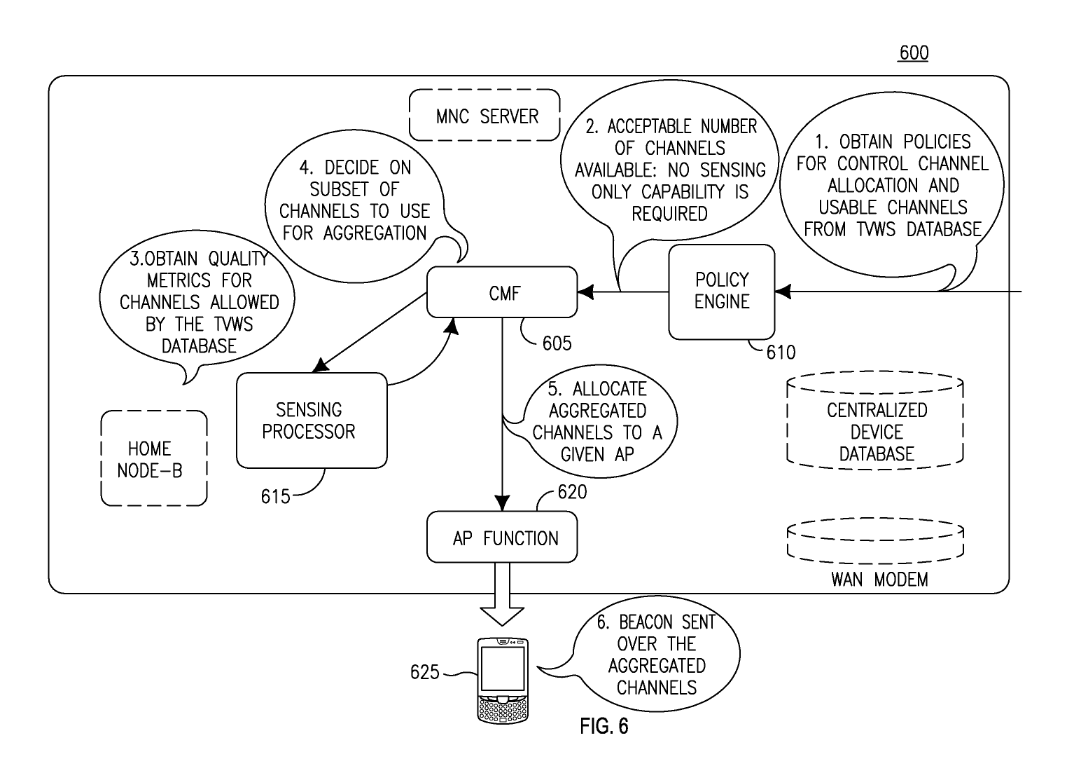

An example control channel initialization with respect to a DSM engine 600 and device 625 is shown in FIG. 6. In this example, a non-sensing only capability may not be supported. Upon power-up of the DSM engine 600, the CMF 605 may determine a pool of available channels based on control channel allocation policy information and usable channel information received from a policy engine 610 (2), which may have obtained the control channel allocation policy information and usable channel information from at least the TVWS database and/or a policy server (not shown but see FIG. 2) (1). The CMF 605 may determine or obtain the quality metrics for the usable or allowable channels from a SP 615 (3). The CMF 605 may then determine on a subset of the channels to use for aggregation (4) and allocate the aggregated channels to each of the AP functions 620 (5).

The CMF 605 may then start sending control messages, such as the beacon, over the aggregated channels with the help of each AP function 620 (6). The control message may be sent simultaneously over the aggregated channels where certain information elements (IEs) are repeated over multiple channels and the rest of the control message is segmented over the aggregated beacon. The repetition of certain IEs may allow a DSM client 625 to discover and synchronize with the aggregated channels used by intercepting a single channel only. The beacon message may inform the DSM clients 625 if one or more channels of the allocated channels are sensing only channels.

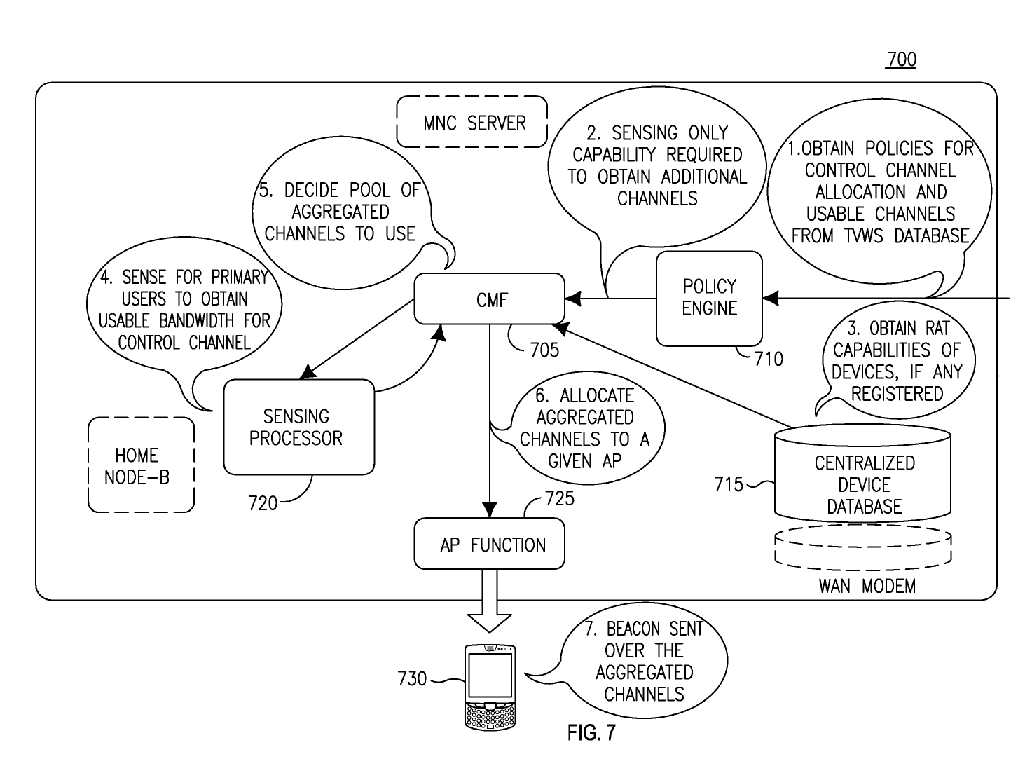

An example control channel initialization with respect to a DSM engine 700 and device 730 is shown in FIG. 7. In this example, a non-sensing only capability may be supported. Upon power-up of the DSM engine 700, the CMF 705 may determine a pool of available channels based on control channel allocation policy information and usable channel information received from a policy engine 710, which may have obtained the control channel allocation policy information and usable channel information from at least the TVWS database and/or a policy server (not shown but see FIG. 2) (1). If the DSM engine 700 cannot allocate the number of channels it requires for the control channel based on the information in the TVWS database, it may use its sensing only capability to verify the usability of additional TV band channels for its control channel initialization (2). The CMF 705 may therefore obtain RAT capabilities of the devices, if any are registered, from the centralized device database 715 and may request the SP 720 to sense for primary users to obtain usable bandwidth for control channel functions (4). The CMF 705 may also determine or obtain the quality metrics for the usable or allowable channels from a SP 720.

The CMF 705 may then determine on a subset of the channels to use for aggregation (5) and allocate the aggregated channels to each of the AP functions 725 (6). The CMF 705 may then start sending control messages, such as the beacon, over the aggregated channels with the help of each AP function 725 (7). The control message may be sent simultaneously over the aggregated channels where certain information elements (IEs) are repeated over multiple channels and the rest of the control message is segmented over the aggregated beacon. The repetition of certain IEs may allow a DSM client 730 to discover and synchronize with the aggregated channels used by intercepting a single channel only. The beacon message may inform the DSM clients 730 if one or more channels of the allocated channels are sensing only channels.

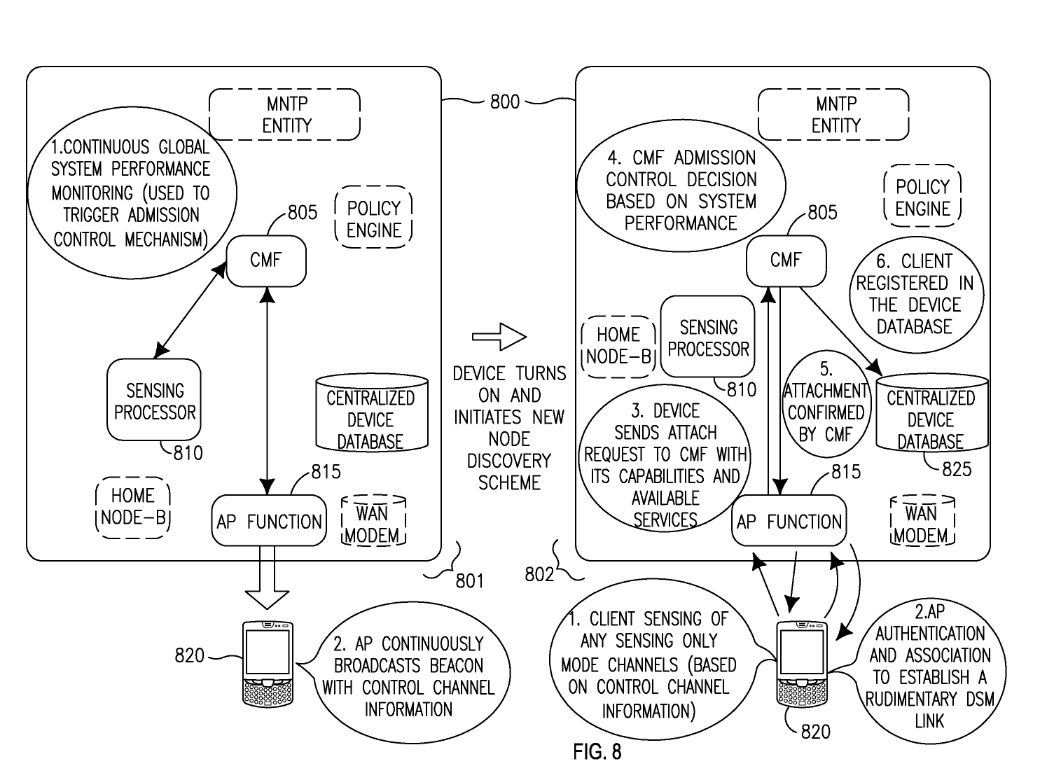

An example device attachment and admission control architecture and method with respect to a DSM engine 800 and device 820 is shown in FIG. 8. In general, any device or AP that joins the network must first attach with a CMF 805 in order to make its presence known. The attachment process allows the DSM engine 800 to control which devices are allowed into the DSM system, based on continuous system performance monitoring by the CMF 805 and available bandwidth/channels. It also allows the CMF 805 to compile a list of clients under its direct management along with the location, capabilities, and properties of each client.

In particular in a first state 801, the CMF 805 may perform continuous global system performance monitoring (1). This may be used to trigger admission control mechanisms. The system monitoring may include a AP function 815 continuously broadcasting beacons with control channel information (2).

In transitioning to a second state 802, a device (i.e., a DSM client) 820 may turn on and initiate a node discovery scheme. In this second state, a sensing stage may be performed in order to confirm the usability of any sensing only mode channels that are used by the DSM engine 800 (1). This may be based on received control channel information. The device 820 and AP function 815 may then perform an AP authentication and association procedure to establish a preliminary DSM link (2). Once association has been performed over a set of allowable channels, the DSM client 820 may send an attachment request with its capabilities and available services to the CMF 805 (3). The CMF 805 may then perform and make an admission control decision based on system performance (4). Upon confirming the success of the attachment procedure (5), the CMF 805 may add the capabilities of the devices or APs and the services they support, to the centralized device database 825 (6). Once a client is registered in the device database, the SP 810 may assign that device sensing tasks to gain additional knowledge about current or future bandwidth utilization.

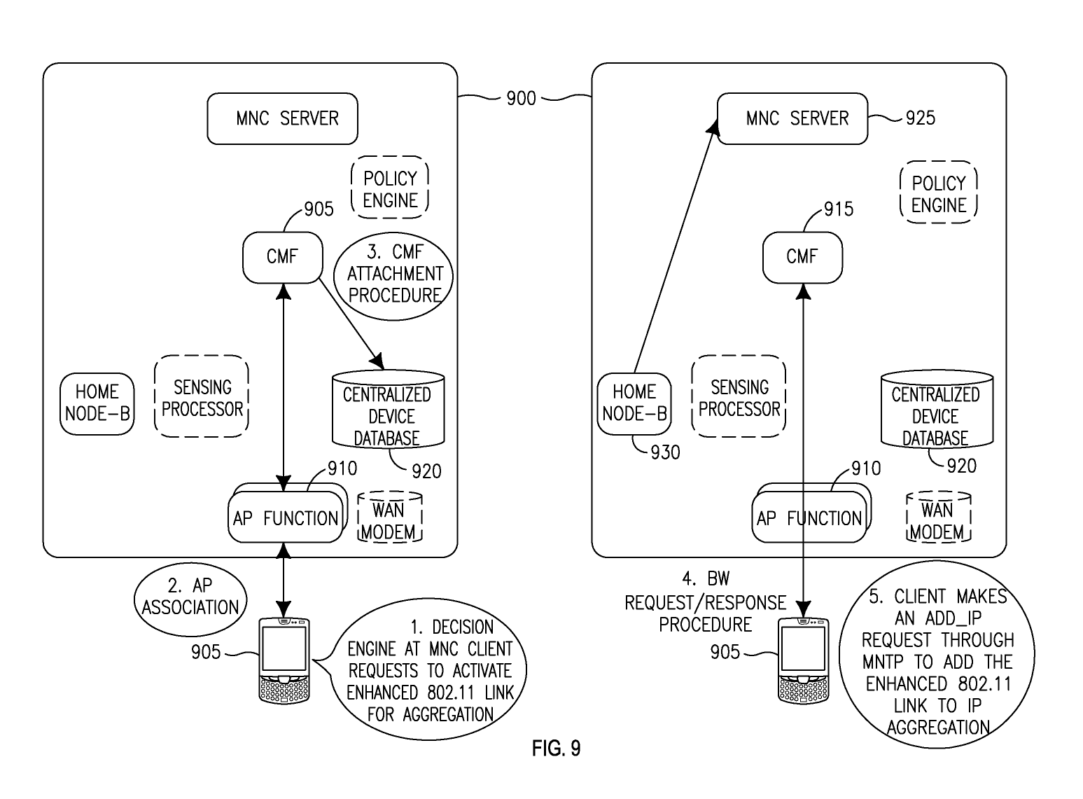

An example IP aggregation architecture and method with respect to a DSM engine 900 and device 905 is shown in FIG. 9. An IP aggregation procedure takes place when a device 905 that is connected through a cellular connection, (as the default MNTP connection), decides to add the DSM link and perform IP aggregation (1). This decision may performed by the IP aggregation decision engine that resides on the MNC client. The decision engine, when it becomes aware of the presence of a DSM link, first activates this link through an attachment procedure as described herein above with a AP function 910, CMF 915 and CDD 920 (2 and 3). When the DSM link is activated, the DSM client 910 may request bandwidth on the DSM link from the CMF 915 (4) and then initiate the IP aggregation through signaling between the MNC client and MNC server 925 over the MNTP, (as shown in FIGS. 3 and 4) (5). For example, the DSM client 905 may make an ADD_IP request through MNTP, (via a H(e)NB 930), to add the enhanced IEEE 802.11 link to the IP aggregation. At this point, the CMF 915 may administer the resources on the DSM link, whereas the IP aggregation decision engine on the DSM client 905 may decide, (using health measurements from each network), whether to add or remove, the DSM link or the cellular link, from the IP aggregation. A current IP aggregation solution may require that the cellular link be the default link, (ADD_IP requests may be made through Third Generation (3G) messages). In one embodiment, IP aggregation may be generalized to also have the default link exist on the DSM link.

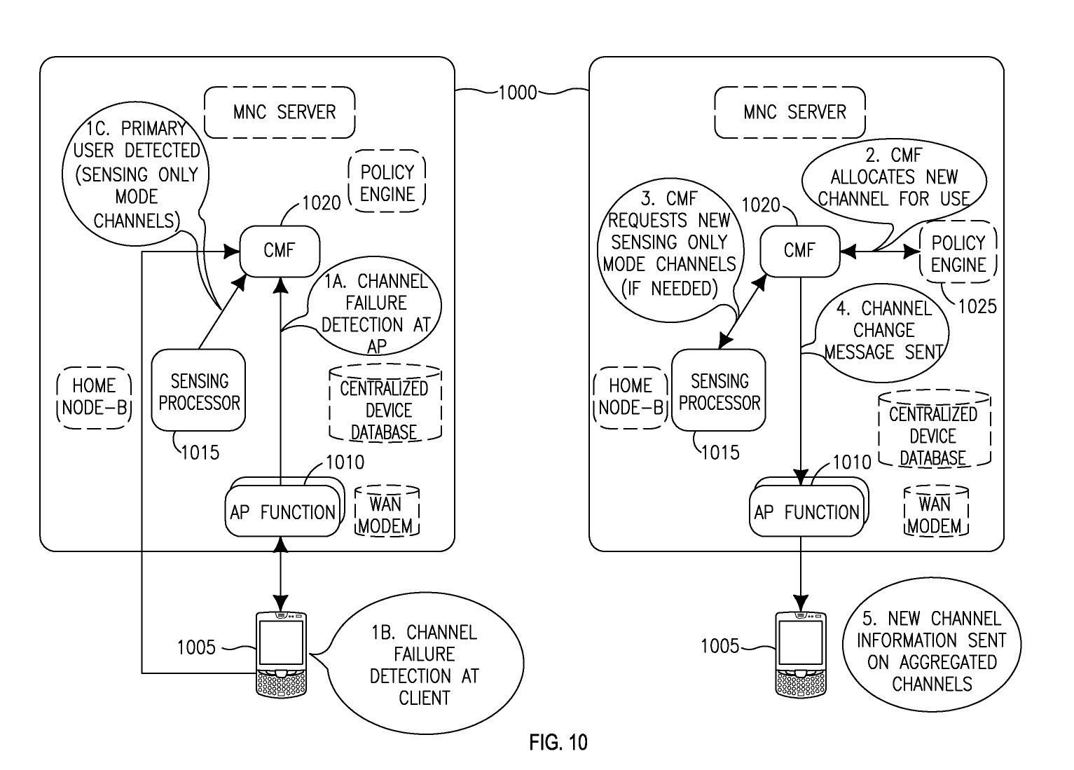

An example channel change procedure with respect to a DSM engine 1000 and a device 1005 is shown in FIG. 10. A channel change may be initiated through several triggers such as for example, a channel failure detection at an AP function 1010 (1a), a channel failure detection at the device 1005 (1b) and/or a primary user detection on sensing only mode channels at the SP 1015 (1c). When a channel failure is detected by the AP function 1010 of the DSM engine 900 or by the DSM link function of the device or DSM client 1005, a message may be sent to a CMF 1020 to notify it of the failure and request a new channel. In addition, in the case where the DSM system is utilizing sensing only channels, the SP 1015 may notify the CMF 1020 that a primary user was detected on one of the channels it has been asked to monitor. In each of these cases, the CMF 0120 may confirm the need for a change of channel with the SP 1015 and then allocate a new channel for use after checking with the policies from the policy engine 1025 and the available channels in the TVWS database (2). As in the case of control channel initialization, this channel may not be available from the control channel perspective and may need to be obtained by the SP 1015 by using sensing only mode (3). When the channel allocation has been made, a channel change message may be sent by the CMF 1020 to the impacted AP 1010 (4), which in turn may transmit the new channel information over the aggregated channels to the device 1005 (5).

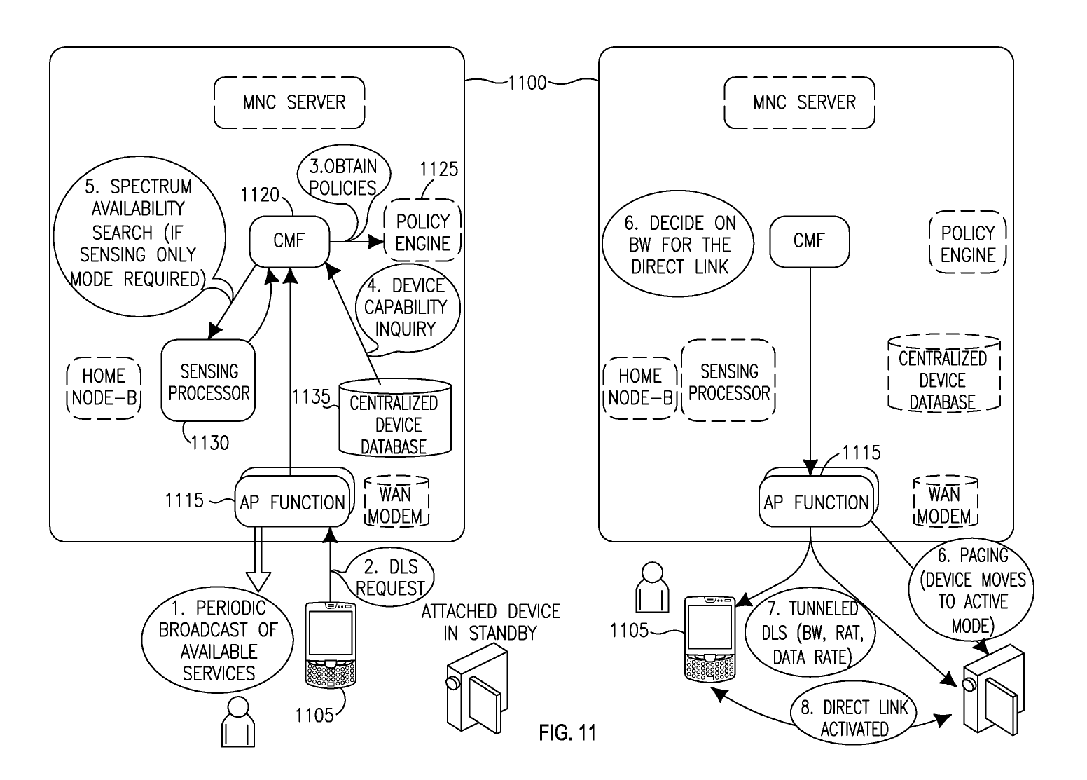

An example direct link setup (DLS) procedure with respect to a DSM engine 1100, a device 1105 and a second device 1110 is shown in FIG. 11. In general, the DLS procedure may be used to establish a direct connection or link between two devices, such as the device 1105 and a second device 1110, over a channel or set of channels allocated by the DSM engine 1100. This link may operate with little or no intervention by the AP function 1115 in the DSM engine 1100.

In order for the device 1105 to be aware of the ability to establish a direct link with another device in its vicinity, for example the second device 1110, it may use the information obtained from a specific control message advertising the available services sent by the DSM engine 1100 to all registered devices (1). The device 1105 may then send a request for the DLS service to the DSM engine 1100 and in particular, the AP function 1115 and eventually a CMF 1120 (2).

Bandwidth for the DLS may be allocated by the CMF 1120 through either database access via a policy engine 1125 (3), or through a spectrum availability search by a SP 1130 in the case there are an insufficient number of channels available based on the TVWS database information (5). The CMF 1120 may obtain device capability information from a CDD 1135 for the device 1105. The CMF 1120 may then determine the bandwidth for the DLS (6) and instruct the AP function 1115 to establish the DLS by first paging the second device 1110 involved in the direct link, and initiating the messaging to establish the bandwidth, RAT, and data rate (7) to be used by the device 1105 and second device 1110 during the direct link (8).

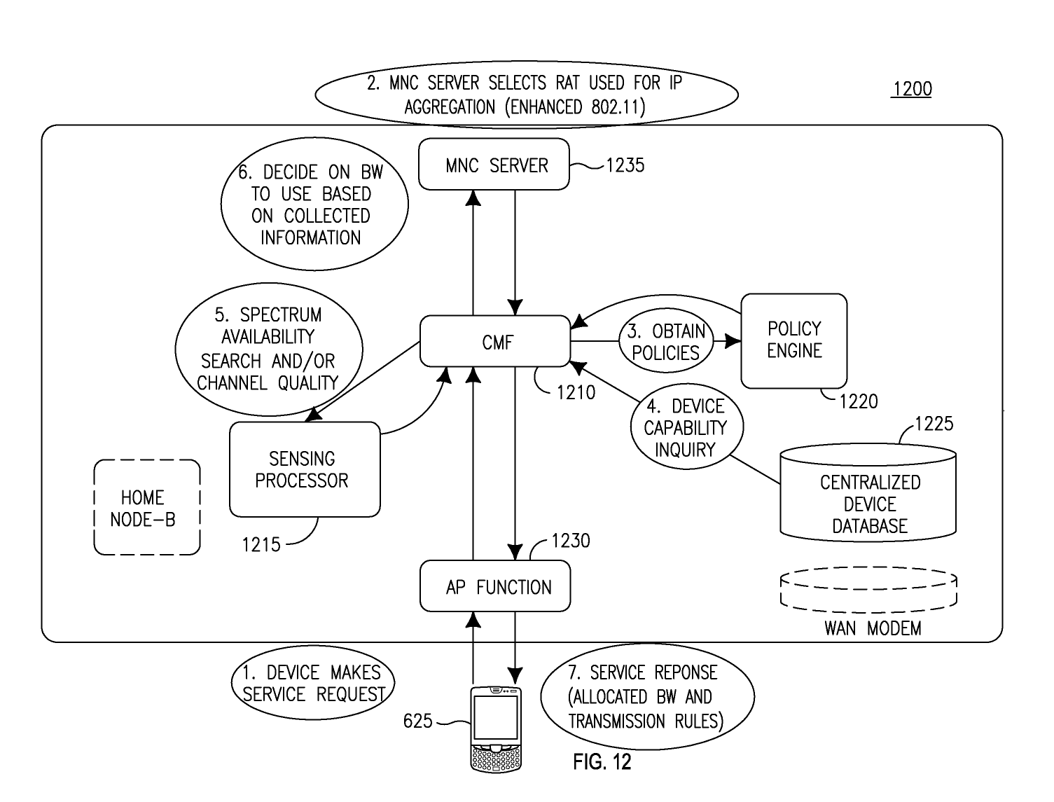

An example service request procedure with respect to a DSM engine 1200 and a device 1205 is shown in FIG. 12. In the event that an application for a device 1205 may need a high and sustained throughput with low latency, the device 1205 may request bandwidth from a CMF 1210 via a AP function 1230 (1). The CMF 1210 may handle the bandwidth requests by checking the active RAT system capability to handle the bandwidth request. The CMF 1210 may interact with the MNC server 1235 to determine or select the RAT (2). In the event that the active RAT cannot handle the request, the CMF may verify if the device may communicate using another available RAT (4). These capabilities are stored and maintained in a CDD 1225 that is written to by the CMF 1210.

When the CMF 1210 receives the request for bandwidth from the device 1205, it may collect the information it needs to allocate channel resources to the device 1205. The CMF 1210 may maintain a local database of allocated and free resources that it may query prior to making spectrum decisions. This information includes the policies from the policy engine and the device capabilities (including RAT capabilities, device class, or location) from the centralized device database. In order to maintain this database, the CMF 1210 may make use of the SP 1215 to sense the available spectrum (5), and the policy engine 1220 to determine which spectrum is usable at a given time based on the TVWS database and the spectrum rules specific to the bandwidth considered (3).

The CMF 1210 may then provide spectrum utilization based on this information (6). This may include of using the available bandwidth information, or requesting the SP 1215 to update this information prior to the allocation, (to get a more recent utilization map). Once the allocation is made, the CMF 1210 transmits a bandwidth response to the requesting device 1205 with the allocated bandwidth and transmission rules to be used including for example aggregation, transmit power and the like (7).

An example resource management and allocation and in particular, basic radio resource management (RRM) and aggregation, and control channel functionality is described herein. Bandwidth resources in the TVWS are centrally pooled and maintained by the CMF. The CMF may perform the RRM tasks of assigning channels to a given AP and its associated DSM clients and managing these channels dynamically based on quality of service (QoS), channel quality, and sensing results at the PHY/MAC layer for detection of interference and primary users in the TVWS bands. The CMF may then track these channels by commanding the appropriate sensing, in order to detect interference during channel utilization. The CMF may also add additional bandwidth to the channel pool used by an AP in case the QoS of the service is not met, and to return the resource back to the resource pool once the service has been rendered and the device no longer requires the bandwidth.

Since clients may generally be sharing the same bandwidth resources using carrier sense multiple access (CSMA), the RRM algorithm may also manage the allocated bandwidth between the users sharing this bandwidth. This management may ensure that user application QoS is satisfied by translating these QoS requirements into different access categories at the MAC layer. Through feedback from the MAC layer, (channel quality based on measured MAC delays, retries, and the like), the RRM algorithm in the CMF may continuously adjust the channel allocation for a client in order to meet the required QoS level. As a result, bandwidth allocation and RRM performed by the CMF is done for the entire DSM system, rather than on a user-by-user basis.

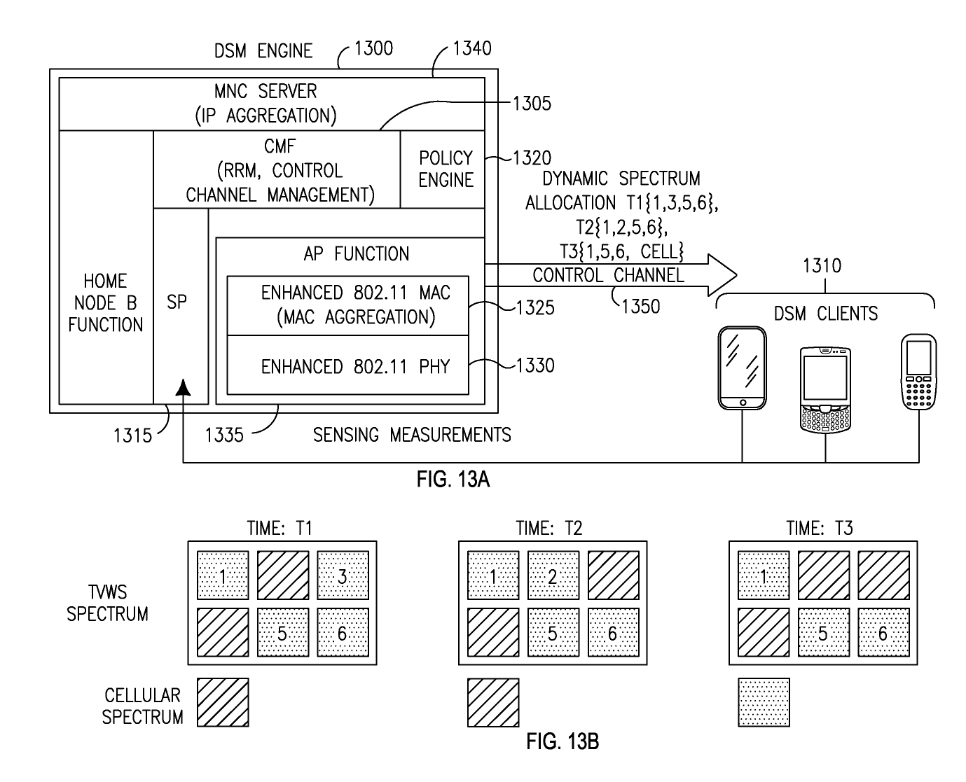

FIGS. 13A and 13B illustrate a high-level view of the RRM tasks performed by a DSM Engine 1300. The CMF 1305 may select the appropriate channels for use by the DSM clients 1310 based on information from a sensing processor 1315 and rules obtained from a policy engine 1320. These decisions may be made by the CMF 1305 after certain events. One event may be triggered by the arrival of a primary user on a sensing only channel. Another event may be triggered by a sudden drop of the QoS for one of the allocated channels. Following these events, the CMF 1305 may decide to change the channels allocated to the AP and its associated DSM clients.

The enhanced IEEE 802.11 MAC layer 1325 of an AP function 1335 may then perform aggregation of the channels selected by the CMF 1305. In addition to this MAC layer aggregation, the DSM engine 1300 may be capable of performing IP layer aggregation via the MNC server 1340. Channel change messages are sent by the DSM engine 1300 to the DSM clients 1310 with little latency over the aggregated channels to ensure robust operation. The DSM clients 1310 may then communicate over the appropriate channels using the corresponding client functions to perform aggregation over the new channels they have been allocated.

The logical control channel 1350 may play a central role in resource allocation by sending updates to the DSM clients 1310 to dynamically reconfigure the aggregation of allocated channels at the MAC and IP layers. For example, as shown in FIGS. 13A and 13B, at different times, denoted T1, T2 and T3, different resource allocations may be sent to the DSM clients 1310. At time T1, TVWS spectrum denoted by blocks 1, 3, 5 and 6 are allocated to the DSM clients 1310. Later at time T2, blocks 1, 2, 5 and 6 and at time T3, blocks 1, 5, 6 and cellular spectrum are allocated to the DSM clients 1310.

The logical control channel 1350 may be under the management of the CMF 1305. The CMF 1305 may ensure that the control channel 1350 is robust by sending a control message over the aggregated channels where certain IEs are repeated over multiple channels and the rest of the control messages are segmented over the aggregated channels. The control channel scheme to be used may be selected by the CMF 1305 based on the available spectrum. In the event that only a limited number of white space channels are available, the control channel 1350 may rely on other techniques to ensure robustness.

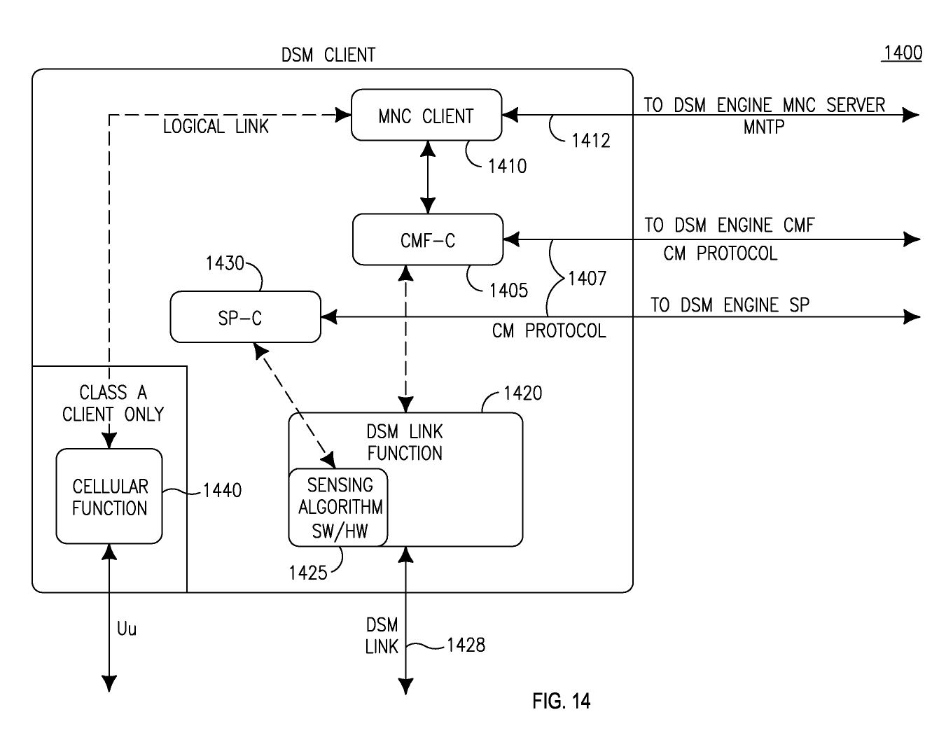

An example DSM client 1400 is shown in FIG. 14. The DSM client 1400 may be divided into logical functions that may include a channel management function-client (CMF-C) 1405 logically connected to a MNC client 1410, and a DSM link function 1420. The CMF-C 1405 may be linked or connected to a DSM engine CMF via a CM protocol 1407. The MNC client 1410 may be linked or connected to a DSM engine MNC server via the MNTP 1412. The DSM link function 1420 may include a sensing algorithm software/hardware module 1425 and may be linked to other devices via a DSM link 1428. The DSM client 1400 may further include a sensing processor-client (SP-C) 1430 that may be logically linked to the sensing algorithm software/hardware module 1425 in the DSM link function 1420 and may be linked or connected to a DSM engine SP via a CM protocol 1407. A cellular function 1440 may also be included for Class A clients and may communicate to other devices using an air interface such as a standard UMTS or LTE air interface.

As shown in FIG. 14, each of the logical functions of the DSM client 1400 may complement one of the logical functions in the DSM engine. As a result, connections exist between the DSM engine function and the corresponding client function.

The CMF-C 1405 is the client function that is connected to the CMF in the DSM engine function. The CMF-C function 1405 may obtain channel resources from the CMF in the DSM engine and ensure that the DSM client 1400 uses these resources in a fashion that is consistent with the allocation rules set forth by the DSM engine (timing, power allocation, and the like). Since the CMF-C 1405 may be connected to the main function in the DSM engine, it may also be responsible for upper layer messaging and control that occurs between the DSM client 1400 and DSM engine. This may include initiation of the attachment procedure with the DSM engine and receiving all control channel configuration/reconfiguration messages that are sent by the DSM engine to all of the clients.

The CMF-C 1405 may manage the DSM link function 1420 within the DSM client 1400. The DSM link function 1420 may provide the DSM client 1400 with the basic MAC/PHY functionality to initiate and maintain connectivity with the DSM engine as well as other DSM clients, (for example, in the case of a direct link). The DSM link function 1420 may implement an enhanced IEEE 802.11 PHY/MAC to be able to receive and decode the new control messages, and to perform MAC layer spectrum aggregation of the channel resources it is configured with by the CMF-C 1405.

The SP-C 1430 may be responsible for performing sensing for detection of primary users on channels that have been tagged by the DSM engine as requiring sensing only capability, (as described hereinbefore). The SP-C 1430 may allow the DSM client 1400 to behave as a sensing only device. It may be instructed as to which of the channels being used may require accurate knowledge of the availability or presence of a primary user. On these channels, the SP-C function 1430 may receive sensing configurations that are sent by the SP and may implement and control the appropriate sensing algorithm to obtain sensing information requested by the SP, (in terms of bandwidth, sensitivity, algorithm type, and the like). This information may be used by the CMF in the DSM engine to derive channel allocations to be used by each of the DSM clients which are requesting bandwidth for communication. In addition, when the client is operating as a Mode I device, the SP-C 1430 may also provide channel quality information for the CMF to enable dynamic resource management on channels that have been selected by the DSM engine from the TVWS database availability information.

In order to support cellular operation, Class A clients may also be equipped with a cellular function. This cellular function may enable the IP-level aggregation of IEEE 802.11-type channels in the ISM and TVWS bands with cellular channels. This IP level aggregation may be provided by the MNC client 1410. The cellular function may also enable the re-direction or reconfiguration of links from the control of the DSM engine to the cellular domain.

The MNC client 1410 may be the main controller of the MNTP protocol for IP aggregation. It may monitor the health of each network and makes decisions on which technology, (i.e., 3G, Global System for Mobile Communications (GSM), IEEE 802.11 or the like), to be used for an active connection and how to aggregate the bandwidth in these technologies. The MNC client 1410 may include a decision engine making decisions on RATs to be used and the use of multi-RAT sessions driven by application need, coordinate IP bandwidth aggregation based on RAT-level measurements, trigger the activation procedure to set up supplementary RATs that are outside the control of the CMF (e.g., cellular) based on RAT measurements, handover/mobility from one RAT to another (Intra DSM and Inter-RAT), and coordinate session transfer (service continuity) from 802.11 to Uu and vice-versa.

The CMF-C 1405 may communicate directly with the CMF in the DSM engine. It may be responsible for obtaining channel resources from the CMF and ensuring that the resources are used and controlled according to the allocation rules determined by the CMF. The CMF-C 1405 may control and implement radio resource allocation as commanded by the DSM engine, (channel switching times and channel configuration), configure the client MAC/PHY function to properly receive control channel information based on the scheme configured by the DSM engine, use robust control channel means, (e.g., re-routing on data channels), to notify the DSM engine when the control channel becomes unusable and initiate the attach procedure to the DSM engine at boot-up or when trying to join a DSM-controlled network.

The CMF-C 1405 may further maintain and send all device RAT capabilities, sensing capabilities, and services to the DSM engine during the attach procedure, receive new control message from the DSM engine and configure the MAC/PHY to transmit on the assigned schedule, support direct link configuration, setup, tear-down, and maintenance, (e.g., assistance when devices move out of range of each other), and send network health metrics to the MNC client decision engine required for IP aggregation decisions. It may further, based on requests from the application or user, generate bandwidth requests to the CMF.

The SP-C 1430 may communicate directly with the SP in the DSM engine. It may control the sensing operation and measurement reports configured by the SP on the DSM client 1400. The SP-C 1430 may receive sensing requests from the SP and configure the MAC/PHY and sensing algorithm to perform the sensing as specified, receive and maintain sensing configurations on a per-channel basis sent by the SP, and allow the DSM client 1400 to behave as a sensing only device and find additional available channels beyond those identified when the device behaves as a Mode I device.

The SP-C 1430 may further perform basic quality measurements on channels where the client acts as a Mode I device, collect sensing results obtained by the MAC/PHY and sensing algorithm and send them to the SP, implement correlation determination procedures configured by the SP and send the resulting correlation information to the SP, and trigger any periodic sensing configured by the SP.

The client MAC/PHY function may provide the connectivity function for the DSM client 1400. The client MAC/PHY function may perform basic IEEE 802.11 MAC/PHY functionality including: device association; device addressing, routing, identification; synchronization and beacon transmission; multicast-broadcast; buffer management and scheduling; device coordination function; MAC segmentation and concatenation; prioritization buffering; transmission, retransmission and filtering of frames; controlling sensing algorithm operation and timing, including silent period management and configuring the PHY for sensing operations; supporting the new control channel schemes; supporting noncontiguous spectrum aggregation; supporting neighbor/node discovery and channel sounding (location estimation) (for 60 GHz); supporting control and data channel setup procedures for the 802.11-based DSM link; generating MAC-layer congestion reports to be sent to the CMF; performing beam forming, (if client supports 60 GHz); supporting a paging mechanism; and performing interference compensation and avoidance based on commands from the CMF-C 1405.

Radio resource management (RRM) for each DSM client 1400 may be controlled by its respective CMF-C 1405 and the corresponding communication link with the CMF in the DSM engine. The DSM engine may be responsible for allocating the resources (i.e., the channels) that each client will use upon request. The CMF-C 1405 may maintain constant communication with the CMF in the DSM client to send quality information and receive channel reconfiguration or allocation messages. The main communication link between the CMF-C 1405 and the CMF on the DSM engine to exchange RRM-related information is the logical control channel. The RRM-related information exchanged may include: initial channels allocated by the CMF for a client; channel change requests made by the client when the observed channel quality is low and QoS can no longer be met; channel reconfiguration messages sent by the CMF to a client to change the channels being used/aggregated; and control channel failure actions communicated by the CMF to each of the clients, (in case a client cannot access information on the control channel). These may be communicated a-priori so that the client may respond adequately in the scenario where it may no longer access the control channel.

DSM clients 1400 who are equipped with the capability to do so may request to setup a direct link with other clients. In this case, traffic may be transferred directly between the clients without having to be routed to the DSM engine (or AP functions). This scenario may arise when the QoS required for a connection requires a direct link, or the CMF-C 1405 determines that the connection would benefit from the direct link.

The CMF-C 1405 may use periodic service broadcasts coming from the CMF to determine which devices in the vicinity support a direct link. The CMF-C 1405 may then decide whether it requires, (or would benefit from), a direct link with one of the supporting devices based on a trigger from the application level, (e.g., request to start a gaming session, download, and the like). Prior to setting up the direct link, the CMF-C 1405 may check with the CMF as to whether the bandwidth resource for the direct link is available. If this is the case, the CMF-C 1405 may then begin the direct link establishment procedure with the peer client. This establishment may take place at the MAC layer using features of the enhanced IEEE 802.11 MAC layer. During the direct link, the clients may continue to monitor the control channel for messages from the DSM engine.

The CMF may continuously monitor the bandwidth of the direct link using information from the sensing processor as well as the CMF-C 1405. In the case where a channel becomes unusable, the CMF may instruct the CMF-C 1405 for each client involved in the direct link to change the channel(s) being used. This may occur for a number of reasons including: the TVWS database indicates a policy change on some allocated channels; a primary user is detected on a channel being used for the direct link by devices operating in sensing only mode; and the QoS can no longer be met. This channel change is communicated through the control channel.

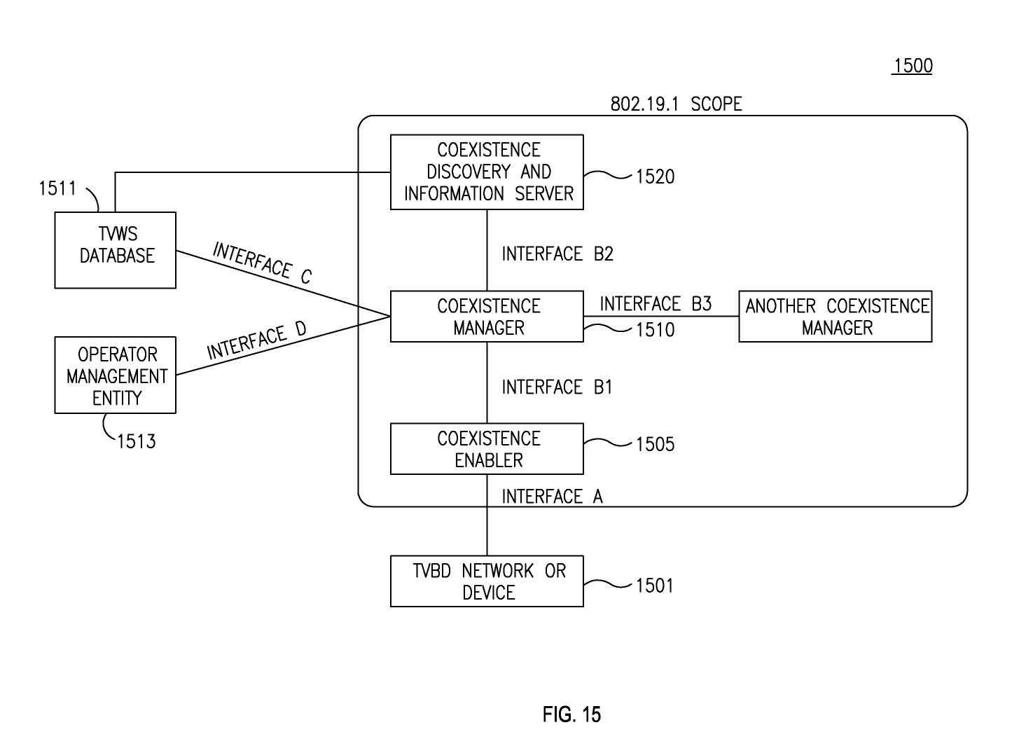

The DSM system architecture as described herein is well aligned and may be mapped with the IEEE 802.19.1 system architecture. The IEEE 802.19.1 architecture attempts to define radio technology independent methods for coexistence among dissimilar or independently operated TVWS networks and devices. As part of this effort, IEEE 802.19.1 has defined a basic system architecture and interface definition 1500 as shown in FIG. 15.

IEEE 802.19.1 has referred to TVWS devices as TV Band Devices (TVBDs) 1501. In addition, the functionality of the IEEE 802.19.1 system has been split into 3 major logical entities, coexistence enabler (CE) 1505, coexistence manager (CM) 1510, and coexistence discovery and information server (CDIS) 1520. The CM 1510 is the entity responsible for making coexistence decisions and supports inter-CM communication. It may also communicate or interface with TVWS database 1511 and operator management entity 1513. The CE 1505 is responsible for making requests “to” and obtaining information “from” TVBD networks or devices, as well as translating reconfiguration requests/commands and control information received from the CM 1510. The CDIS 1520 is responsible for collecting, aggregating, and providing information that facilitates the coexistence.

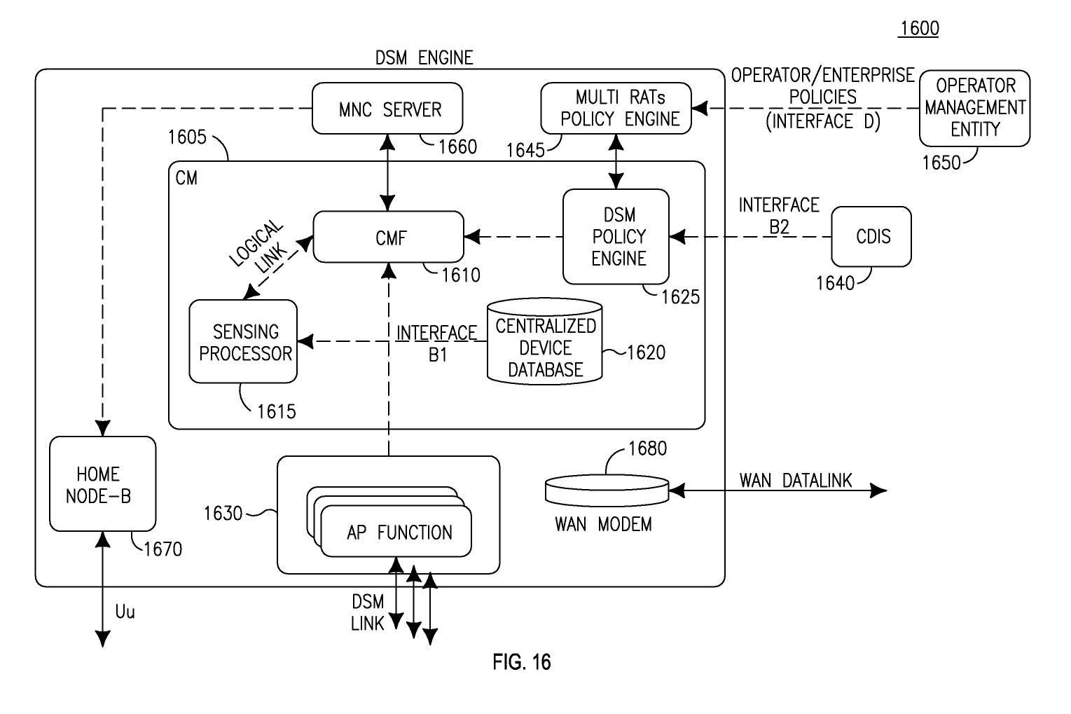

FIG. 16 illustrates the mapping of the IEEE 802.19.1 TVWS coexistence system to the DSM engine 1600. Since CM 1605 is the main decision making entity, it may consist of a CMF 1610, a sensing processor 1615, a centralized device database 1620 and a DSM policy engine 1625, all of which are logically connected. The CM 1605 may configure different networks via interface B1 and communicate through the networks with the CE 1630, which may include the AP function 1635 in this example. The AP functions 1635 may get commands from the CMF 1610 and configure itself according to those commands.

The DSM policy engine 1625 in the CM 1605 may communicate to the CDIS 1640 via interface B2. It queries the CDIS 1640 for the list of available channels and also report back the channel(s) the DSM engine is using and various other characteristics of the channel including, but not limited to, channel load, transmit power, signal-to-noise ratio, medium access delay, and the like. The CDIS 1640 may also periodically send updates of the available spectrum to the DSM policy engine 1625. The DSM policy engine 1625 may communicate with a multi RATs policy engine 1645, which in turn may communicate with an operator management entity (OME) 1650. The CMF 1610 may also be connected to a MNC server 1660, which in turn may be connected to a H(e)NB 1670. As described herein, the DSM engine may also include a WAN modem 1680.

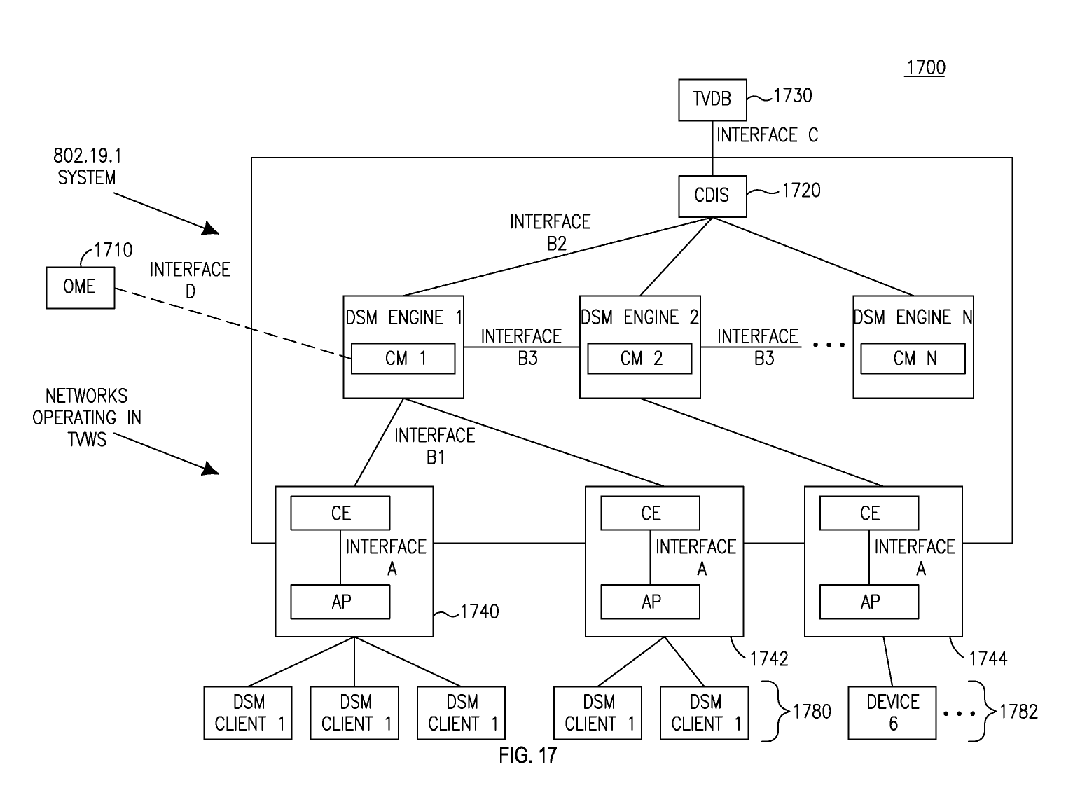

FIG. 17 provides a hierarchical view of an example IEEE 802.19.1 system with multiple DSM entities such as DSM engines and clients. This hierarchical system 1700 may be one example of how a DSM system may be implemented together with IEEE 802.19.1. System 1700 may include multiple DSM engines 1, 2, . . . , N interconnected using B3 interfaces. Each DSM engine includes a corresponding CM1, CM2, . . . , CMN. The DSM engines 1, 2, . . . , N may be further connected to an OME 1710 and to a CDIS 1720, which in turn may be connected to a TVDB 1730. The DSM engines 1, 2, . . . , N may be connected to CE and AP modules 1740, 1742 and/or 1744, which in turn may be connected to specific DSM clients 1780 and devices 1782.

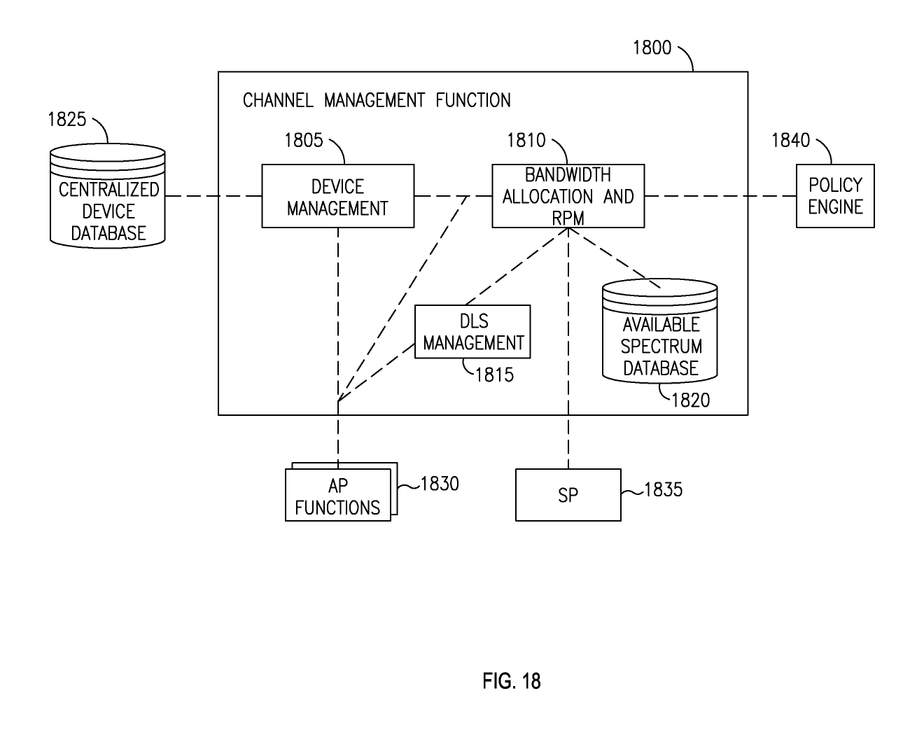

Example CMF sub-functions are shown in FIG. 18. A CMF 1800 may be divided into a device management entity 1805, a bandwidth allocation and RRM entity 1810, a DLS management 1815 and an available spectrum database 1820. The device management entity 1805 may control the attachment and admission control of each device and AP which joins the DSM network. It may manage the CDD 1825, including the addition/removal of entries in the database and updating information related to each entry as per the messages forwarded by an AP function 1830.

The DLS management entity 1815 may be responsible for the establishment, management and tracking of direct links within the DSM engine. It interacts with the AP functions 1830 to establish the required procedures for setting up direct links between devices that request them or that would benefit from their establishment.

The bandwidth allocation and RRM entity 1810 may play the central role in the CMF 1800. It is the main spectrum allocation manager that makes most of the decisions in terms of bandwidth allocations and RRM tasks. It may maintain a link with a SP 1835 and is therefore responsible for all communication on that front. The bandwidth allocation and RRM entity 1810 may communicate with a policy engine 1840 to determine allowable channels based on policies and TVWS database information; communicate with the SP 1835 to configure sensing for quality measurements on used channels as well as searches for additional channels when the channels from the TVWS database are insufficient for network usage; handle events from the SP 1835 concerning the appearance of primary users; collect and process quality measurements on all channels to enable RRM; and manage resources to allow QoS for all services in the DSM system. The bandwidth allocation and RRM entity 1810 may also maintain a logical link with the device management entity 1805 in order to request devices' RAT capabilities for bandwidth allocation.

The available spectrum database 1820 may be updated by the bandwidth allocation and RRM entity 1810 whenever a change in the available spectrum is made due to allocations made by it or due to the freeing of bandwidth. It may also update the database 1820 based on queries made to the policy engine 1840 with regards to the usage of the TVWS bands as well as sensing information.

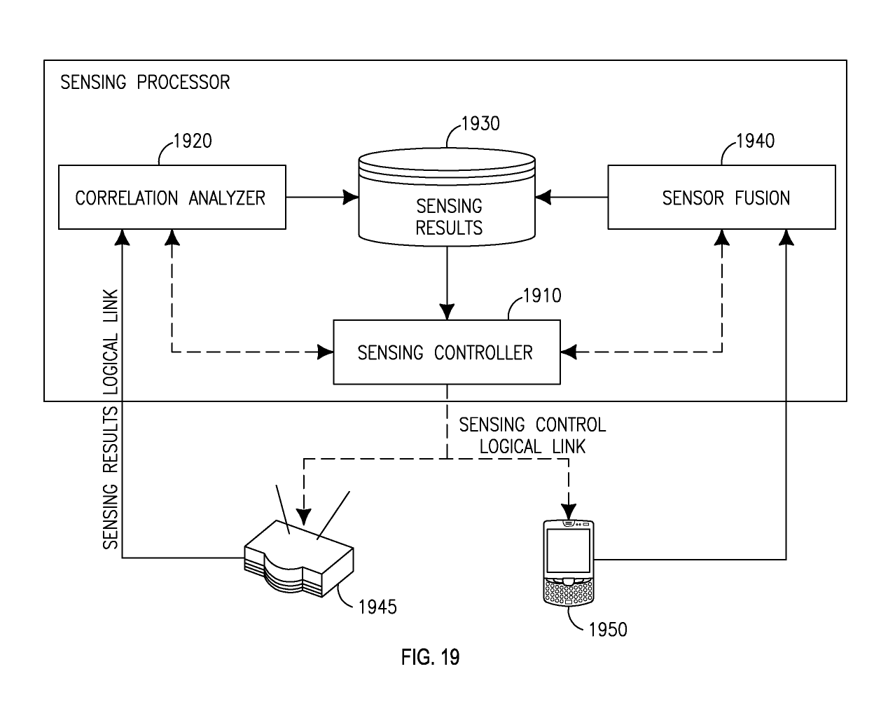

Example SP sub-functions are shown in FIG. 19. A SP 1900 may include a sensing controller 1910 control logically linked to a correlation analyzer 1920 and a sensor fusion 1930 and sensing results logically linked to a sensing results database 1940. The correlation analyzer 1920 and a sensor fusion 1930 are sensing results logically linked to the sensing results database 1940. The sensing controller may be logically linked to sensing nodes 1945 and 1950. The sensing node 1945 may be sensing results logically linked to the correlation analyzer 1920 and the sensing node 1950 may be sensing results logically linked to the sensor fusion 1930.

The sensing controller 1930 may handle spectrum search requests and spectrum monitoring requests from the CMF, send sensing commands to the sensing nodes to configure/control sensing performed in each sensing node based on the correlation between them, configure the correlation analyzer and sensor fusion sub-functions to collect and analyze sensing results based on the current sensing task and obtain the final sensing results from the sensing database 1940 and return them to the CMF.

Based on requests for spectrum sensing from the CMF, the sensing controller 1910 may select the appropriate sensing nodes to perform sensing on the targeted bandwidth or channel. This selection may be made based on location and sensing capability information in the CDD of the DSM engine. The sensing controller 1910 may then communicate with each of the sensing nodes involved in a particular sensing operation and may control the timing of the sensing operations, the division of labor between the sensing nodes, and the type of sensing to be performed by each node. In doing so, the sensing controller 1910 may also configure the correlation analyzer 1920 and sensor fusion 1930 to be able to analyze the sensing results based on the task being performed. Each sensing task may be assigned a specific ID by the sensing controller 1910. Once sensing results have been analyzed and stored, the sensing controller 1905 may be able to provide information to the CMF about the vacancy or occupancy of each channel being sensed or monitored.

The sensing controller 1905 may send back occupancy information to the CMF. This occupancy information may be in two forms: a message to the CMF to indicate that a channel of interest is experiencing interference, (from either a primary user or from an external interference source or secondary network), as well as channel quality indications on the channel that may be used by the CMF to decide whether a channel should be used or avoided. In addition to the sensing controller 1905, the CMF receives MAC-layer utilization and congestion reports from the MAC layer, (based on acknowledgement times, medium access times, and the like). These metrics are independent from those reported by the sensing controller 1910 to the CMF.

The correlation analyzer 1920 may analyze the potential correlation between the sensing results that will be generated by the sensing nodes. In order to more efficiently coordinate future sensing tasks, the sensing controller needs to determine the correlation between sensing nodes at any given time. It therefore may configure a special set of measurements which are performed by each of the sensing nodes and collected and analyzed by the correlation analyzer 1920. The correlation analyzer 1920 may perform certain analysis algorithms which determine how strongly or weakly correlated sensing results may be between different nodes in the network. Based on these results, which are stored in the sensing results database 1940, the sensing controller 1910 may configure sensing operations to have the most efficient use of sensing resources, (e.g., battery power, silent period and the like) within the network managed by the DSM engine.

The sensor fusion 1930 may perform fusion of sensing results from multiple sensing nodes performing measurements on the same channel or bandwidth. This fusion may result in a centralized decision about the availability of a particular band based on independent sensing results or decisions made by multiple nodes involved in sensing. The sensor fusion 1930 may store the centralized decisions, as well as the individual sensing results from each of the sensory nodes, in the sensing results database 1940. The sensor fusion 1930 may be configured based on the results from the sensor correlation.

The sensing results database is the central repository for information in the SP 1900. It stores elements including a list of nodes currently involved in sensing, correlation results giving the degree of correlation between each of the nodes, fused sensing results, (channel occupancy and channel quality metrics), and individual sensing results collected from each node.

Although features and elements are described above in particular combinations, one of ordinary skill in the art may appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A dynamic spectrum management (DSM) engine, comprising:
a policy engine configured to maintain policies and opportunistic spectrum availability information; and
a channel management function (CMF) linked to the policy engine and configured to obtain opportunistic spectrum resource information from at least the policy engine to maintain a pool of opportunistic spectrum resources, perform radio resource management (RRM) and allocate aggregated spectrum resources in response to requests from devices that have been admitted by the CMF.

2. The DSM engine of claim 1, wherein the CMF further comprises a control channel management function configured to send the aggregated spectrum resources to the devices and dynamically update and reconfigure the aggregated spectrum resources.

3. The DSM engine of claim 1, further comprising a sensing processor (SP), wherein the CMF is further configured to identify and maintain the pool of opportunistic spectrum resources with assistance from the SP.

4. The DSM engine of claim 1, further comprising:
a control plane protocol stack including at least one of:
a multi network transport protocol (MNTP) configured to establish multiple parallel sessions over multiple radio access technologies (RATs) between the devices and the DSM engine and perform internet protocol (IP) aggregation of multiple IP streams;
a channel management (CM) protocol configured to handle wireless communications operating in the opportunistic spectrum and provide admission control of devices and base station radio resources;
a policy protocol configured to generate policy rules based on an opportunistic band database and rules;
a medium access control (MAC) entity and a physical entity configured to support cognitive sensing techniques, coexistence with multiple RATs and operation over noncontiguous spectrum in opportunistic bands using a wideband digital radio; or
an air interface configured to enable IP aggregation over both licensed and opportunistic bands.

5. The DSM engine of claim 4, further comprising:
a user plane protocol stack including at least one of:
a MNTP configured to perform Internet Protocol (IP) aggregation; and
a MAC entity and a PHY entity configured to support operation over noncontiguous spectrum in opportunistic bands using a wideband digital radio and handle DSM links.

6. The DSM engine of claim 1, wherein the opportunistic spectrum resources include at least one of unlicensed spectrum, leased spectrum, sublicensed spectrum or television white space.

7. The DSM engine of claim 1, wherein the CMF is configured to dynamically select aggregated spectrum resources.

8. The DSM engine of claim 1, further comprising:
a centralized device database (CDD) configured to store device information for devices associated with the DSM engine; and
the CMF configured to read and write information from and to the CDD regarding the devices.

9. The DSM engine of claim 8, wherein the CDD includes sensing capability, RAT capability, device location, sensor fusion capability and connection state.

10. The DSM engine of claim 1, wherein the CMF is configured to change the allocated aggregated resources in response to event triggers including quality of service changes and primary user detection on sensing only channel.

11. A dynamic spectrum management (DSM) client, comprising:
a channel management function-client (CMF-C) configured to obtain allocated aggregated spectrum resources from a channel management function (CMF) and handle control communications with the CMF;
a multi network connection (MNC) client configured to enable IP aggregation and determine network health from network information received from the CMF-C; and
a DSM link function configured to initiate and maintain connectivity with a DSM engine, the DSM link function being managed by the CMF-C.

12. The DSM client of claim 11, comprising:
a sensing processor-client (SP-C) configured to receive sensing information from a sensing processor (SP) and sense for primary users on the allocated aggregated spectrum resources based on at least the sensing information.

13. The DSM client of claim 11, wherein the CMF-C comprises a client MAC/PHY function configured to provide a connectivity function for the DSM client.

14. The DSM client of claim 11, wherein the allocated aggregated spectrum resources include at least one of licensed and opportunistic bands.

15. The DSM client of claim 14, wherein the opportunistic bands include at least one of unlicensed bands, leased bands, sublicensed bands or television white space bands.

16. A method of dynamic spectrum management (DSM), comprising:
determining, by a CMF, a pool of available channels;
on a condition that a sensing mode is supported and the pool of available channels is deficient, using the sensing mode to determine usability of additional channels in opportunistic bands;
selecting channels from the pool of available channels;
allocating aggregated channels from the pool of available channels for a control channel; and
transmitting a control message over the aggregated channels to the devices.

17. The method of claim 16, further comprising:
continuously monitoring, by the CMF, of system performance to trigger admission control;
continuously broadcasting, by a base station, control channel information;
performing authentication and association, by the base station, with the device;
receiving an attachment request with device capabilities from the device;
performing admission control by the CMF;
confirming device attachment by the CMF; and
registering the device in a client device database (CDD) by the CMF.

18. The method of claim 16, further comprising:
aggregating selected channels at the internet protocol (IP) layer over at least licensed bands or unlicensed bands; and
aggregating noncontiguous selected channels at the medium access control (MAC) layer.

19. The method as in claim 16, further comprising:
deriving a list of initial channels used by a DSM engine based on information gathered by the devices in sensing only device mode and information received from a opportunistic band database; and
sending the list to the devices by the DSM engine and informing the devices whether one or more channels of the allocated aggregated channels are sensing only channels.

20. The method as in claim 16, wherein the aggregated channels include at least one of unlicensed channels, leased channels, sublicensed channels or television white space channels.
